(19) United States
(12) Patent Application Publication
(10) Pub. No.: US 2013/0085831 A1
(43) Pub. Date: Apr. 4, 2013

(54) VENUE MANAGEMENT SYSTEM AND METHOD

(71) Applicants: Larry D. Witherspoon, JR., Tustin, CA (US); J. Bret Armatas, Upland, CA (US)

(72) Inventors: Larry D. Witherspoon, JR., Tustin, CA (US); J. Bret Armatas, Upland, CA (US)

(73) Assignee: Alvarado Manufacturing Company, Inc., Chino, CA (US)

(21) Appl. No.: 13/341,447

(22) Filed: Dec. 30, 2011

Related U.S. Application Data
(62) Division of application No. 13/250,017, filed on Sep. 30, 2011.

(51) Int. Cl. G06Q 30/02

(52) U.S. Cl. 705/14.27; 705/14.1

(57) ABSTRACT

A venue management system and method that effectively integrates and automates access control systems, membership and/or loyalty programs, and similar programs and systems to allow a sports team or other organization to more effectively monitor and track ticket holders' attendance histories, purchase histories, spending patterns and other behaviors and to provide rewards and other incentives more closely tied to these behaviors.

### RELATED APPLICATION

This is a divisional of application Ser. No. 13/250,017 filed Sep. 30, 2011, which is hereby incorporated in its entirety by reference herein.

### BACKGROUND

Many professional sports teams and other organizations have membership and/or loyalty programs, customer relationship management (CRM) systems, and similar programs and systems that strive to retain existing fans and attract new ones by rewarding them with points, free products, services, and/or other incentives. Unfortunately, many such programs and systems are not integrated and thus don't provide enough information to effectively reward fans and increase revenue for venues, teams, sponsors and associates. For example, many sport stadiums and other venues have access control systems that provide attendance history information, but these systems don't provide data about fans' purchase histories or spending habits. Similarly, membership and/or loyalty programs may provide incentives to ticket holders, but they often don't track ticket holders' attendance, purchase histories, etc. and therefore don't tailor the incentives to desired fan behaviors. Known membership and/or loyalty programs also don't allow ticket holders to effectively manage their accounts and don't allow venues to create custom incentive programs.

### SUMMARY

The present invention solves the above-described problems and related problems and provides a distinct advance in the art of membership and/or loyalty programs and similar programs. More particularly, embodiments of the present invention provide a venue management system that effectively integrates and automates access control systems, membership and/or loyalty programs, and similar programs and systems to allow a sports team or other organization to more effectively monitor and track ticket holder, member and attendees' attendance histories, purchase histories, spending patterns, social media activities and other behaviors and to provide rewards and other incentives more closely tied to these behaviors as well as to allow the tailoring of incentives to influence the behavior of such persons. The venue management system also allows ticket holders to create on-line accounts to more easily and effectively manage their ticket and membership accounts and allows venue operators to create custom incentive programs to increase fan loyalty and revenue for venues, teams, sponsors and associates.

One embodiment of the venue management system implements a web-based patron portal that permits ticket holders and other patrons to create accounts and to store ticket identification information in the accounts. A ticket holder may access his or her account, store ticket information in the account, associate a stored value with a ticket, card or account to allow the purchase of products and services within and outside the venue. When the ticket is presented to a vendor in the venue and scanned or otherwise identified by a point of sale (POS) station, the POS station communicates with the venue management system to verify the stored value associated with the ticket and to update the stored value to account for the sale. The ticket holder may also access the account at anytime and add additional stored value to the ticket, transfer stored value to other tickets, and otherwise manage his or her tickets in real-time so that changes to a ticket can be made during an event.

A company, person, or other entity with multiple ticket accounts may store ticket information for all of them in a single account in the patron portal so that all the tickets may be managed from a single point. For example, the ticket owner may assign a stored value to some or all tickets and may subsequently move stored value between the tickets.

The venue management system may also implement membership and/or loyalty programs that provide rewards and other incentives that are directly tied to a ticket holder's attendance history, purchase history, spending pattern, or other behavior. For example, the system may receive information from an access control system to track when patrons enter the venue and/or from a point of sale system to track purchases in the venue and/or from a sponsor system to track attendance or purchases at locations outside the venue and then provide rewards for these behaviors.

The venue management system may also implement a web-based administration portal that may be accessed by venue administrators to manage the membership and/or loyalty programs. The administration portal may allow the implementation of rules that create incentives or rewards that reward or influence desired fan behaviors. For example, the administrator may create a rule that tracks all ticket holders that arrive in a venue before a particular time and then automatically assigns a stored value (e.g. $5.00) or a free product (soda, hot dog, etc.) to the tickets of these ticket holders to encourage patrons to arrive early. Rules may also be created to reward in-game events. For example, rules may be created to provide all patrons stored value and/or a free product if a home team scores a particular number of points or performs some other activity or may reward certain patrons (e.g. all those sitting in section A) upon the occurrence of some event. The rules engine may also automatically implement certain rules.

The venue management system also allows a venue to offer coupons and other incentives from marketing partners, through the rules engine. The coupons may be stored or viewed in the patrons' accounts and/or associated with the patrons' tickets or accounts. Patrons may use their stored value, points, and/or coupons to purchase products or services within the venue, outside the venue, at retail partners, or through other means of integration or redemption.

The venue management system may also allow patrons to link their accounts with other membership programs and to swap points and other rewards between the programs. For example, a patron may link his or her account to an airline's frequent flyer account and swap points between the accounts at some pre-determined exchange rate.

The present invention offers numerous advantages not realized by many prior art membership and/or loyalty programs and similar programs. For example, by integrating data and other information from access control systems, membership and/or loyalty programs, point of sale systems, social media activity and other systems and programs, embodiments of the present invention allow a venue to gain a better understanding of its fans and their behaviors and then create custom incentive programs that are both timely and meaningful to the fans, teams, venues, sponsors and affiliates. For example, a venue administrator may create a rewards or incentive program tied to attendance, entry or exit times, spending patterns, or virtually anything the venue or team believes is an important behavior to track and influence. The rewards or incentives can also be tied to behaviors that occur out of the venue to track or influence behaviors important to sponsors or affiliates. The invention also allows an administrator to quickly and easily enhance and/or create new rewards programs to keep them fresh and relevant to desired fan or user behaviors. Moreover, by implementing a web-based patron portal that may be accessed by fans to create accounts and manage their tickets and rewards, fans are allowed to more effectively interact with the membership and/or loyalty programs and are therefore more likely to use and benefit from them.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of exemplary computer and communications equipment that may be used to implement embodiments of the invention.

FIG. 2 is an exemplary screen display that may be presented by one or more computer programs of the present invention.

FIG. 3 is another exemplary screen display that may be presented by the computer programs of the present invention.

FIG. 4 is another exemplary screen display that may be presented by the computer programs of the present invention.

FIG. 5 is another exemplary screen display that may be presented by the computer programs of the present invention.

FIG. 6 is another exemplary screen display that may be presented by the computer programs of the present invention.

FIG. 7 is another exemplary screen display that may be presented by the computer programs of the present invention.

FIG. 8 is another exemplary screen display that may be presented by the computer programs of the present invention.

FIG. 9 is another exemplary screen display that may be presented by the computer programs of the present invention.

FIG. 10 is another exemplary screen display that may be presented by the computer programs of the present invention.

FIG. 11 is another exemplary screen display that may be presented by the computer programs of the present invention.

FIG. 12 is another exemplary screen display that may be presented by the computer programs of the present invention.

FIG. 13 is another exemplary screen display that may be presented by the computer programs of the present invention.

FIG. 14 is another exemplary screen display that may be presented by the computer programs of the present invention.

FIG. 15 is another exemplary screen display that may be presented by the computer programs of the present invention.

FIG. 16 is another exemplary screen display that may be presented by the computer programs of the present invention.

FIG. 17 is another exemplary screen display that may be presented by the computer programs of the present invention.

FIG. 18 is another exemplary screen display that may be presented by the computer programs of the present invention.

FIG. 19 is another exemplary screen display that may be presented by the computer programs of the present invention.

FIG. 20 is another exemplary screen display that may be presented by the computer programs of the present invention.

FIG. 21 is another exemplary screen display that may be presented by the computer programs of the present invention.

FIG. 22 is another exemplary screen display that may be presented by the computer programs of the present invention.

FIG. 23 is another exemplary screen display that may be presented by the computer programs of the present invention.

FIG. 24 is another exemplary screen display that may be presented by the computer programs of the present invention.

FIG. 25 is another exemplary screen display that may be presented by the computer programs of the present invention.

FIG. 26 is another exemplary screen display that may be presented by the computer programs of the present invention.

FIG. 27 is another exemplary screen display that may be presented by the computer programs of the present invention.

FIG. 28 is another exemplary screen display that may be presented by the computer programs of the present invention.

FIG. 29 is another exemplary screen display that may be presented by the computer programs of the present invention.

FIG. 30 is another exemplary screen display that may be presented by the computer programs of the present invention.

FIG. 31 is another exemplary screen display that may be presented by the computer programs of the present invention.

FIG. 32 is another exemplary screen display that may be presented by the computer programs of the present invention.

FIG. 33 is another exemplary screen display that may be presented by the computer programs of the present invention.

FIG. 34 is another exemplary screen display that may be presented by the computer programs of the present invention.

FIG. 35 is another exemplary screen display that may be presented by the computer programs of the present invention.

FIG. 36 is another exemplary screen display that may be presented by the computer programs of the present invention.

FIG. 37 is another exemplary screen display that may be presented by the computer programs of the present invention.

FIG. 38 is another exemplary screen display that may be presented by the computer programs of the present invention.

FIG. 39 is another exemplary screen display that may be presented by the computer programs of the present invention.

FIG. 40 is another exemplary screen display that may be presented by the computer programs of the present invention.

FIG. 41 is another exemplary screen display that may be presented by the computer programs of the present invention.

FIG. 42 is another exemplary screen display that may be presented by the computer programs of the present invention.

FIG. 43 is another exemplary screen display that may be presented by the computer programs of the present invention.

FIG. 44 is another exemplary screen display that may be presented by the computer programs of the present invention.

FIG. 45 is another exemplary screen display that may be presented by the computer programs of the present invention.

FIG. 46 is another exemplary screen display that may be presented by the computer programs of the present invention.

FIG. 47 is another exemplary screen display that may be presented by the computer programs of the present invention.

FIG. 48 is another exemplary screen display that may be presented by the computer programs of the present invention.

FIG. 49 is another exemplary screen display that may be presented by the computer programs of the present invention.

FIG. 50 is another exemplary screen display that may be presented by the computer programs of the present invention.

FIG. 51 is another exemplary screen display that may be presented by the computer programs of the present invention.

FIG. 52 is another exemplary screen display that may be presented by the computer programs of the present invention.

FIG. 53 is another exemplary screen display that may be presented by the computer programs of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, function, act, etc. described in one embodiment may also be included in other embodiments, but is not necessarily included. Thus, the present technology can include a variety of combinations and/or integrations of the embodiments described herein.

Embodiments of the invention provide a venue management system and method that may be used by sports teams or other organizations to provide services to ticket holders, fans, ticket administrators and other patrons. The system and method may be used with a sports stadium, convention center, entertainment center, or any other venue and is not limited to any particular sport or entertainment market.

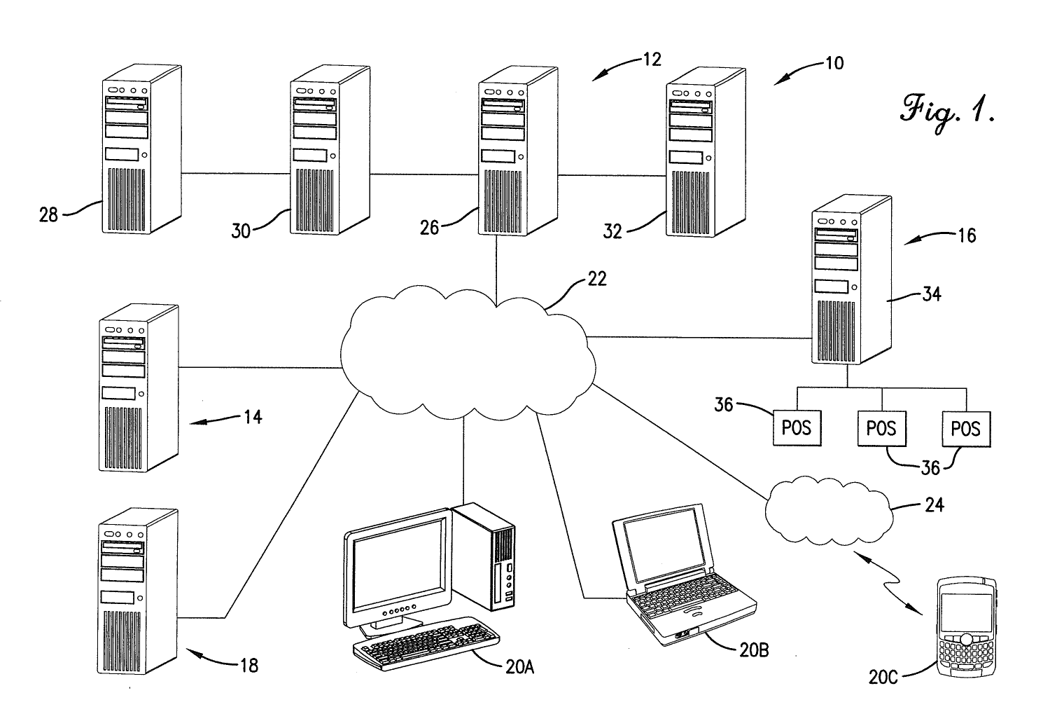

Aspects of the invention can be implemented in hardware, software, firmware, or a combination thereof. In one embodiment, the invention may be at least partially implemented with computer and communications equipment broadly referred to by the numeral 10 in FIG. 1. An embodiment of the computer and communications equipment 10 includes a venue management system 12, an access control system 14, a venue point of sale system 16, one or more marketing partner systems 18, one or more computing devices 20A, 20B, 20C operated by patrons, a communications network 22 and a wireless telecommunications network 24. The components of the computer and communication equipment 10 illustrated and described herein are merely examples of equipment that may be used to implement embodiments of the present invention and may be replaced with other equipment without departing from the scope of the present invention.

In more detail, the venue management system 12 provides a web-based patron portal that may be accessed by fans and other patrons and that serves as a repository for ticket holder accounts and related information. The venue management system 12 also provides a web-based administrative portal that may be accessed by venue administrators and others and that executes a rules engine and other computer programs; and that implements other aspects of the invention as described in more detail below.

Embodiments of the venue management 12 may include one or more servers running Windows; LAMP (Linux, Apache HTTP server, MySQL, and PHP/Perl/Python); Java; AJAX; NT; Novel Netware; Unix; or any other software system and includes or has access to computer memory and other hardware and software for receiving, storing, accessing, and transmitting information as described below. The venue management system 12 also includes conventional web hosting operating software, searching algorithms, an Internet connection, and is assigned a URL and corresponding domain name such as “venueview360.com” so that websites hosted thereon can be accessed via the Internet in a conventional manner.

One particular embodiment of the venue management system 12 comprises a web server 26, a database server 28, an application server 30, and an FTP server 32. One of the servers 26, 28, 30, 32 may host and support software and services of proprietary mobile application providers such as Google, Apple, and Blackberry. The number and type of servers in the venue management system 12 is a matter of design choice and may depend on the number of ticket holder accounts stored in the system and the number of requests and other queries received by the system 12. Thus, the invention is not limited to the specific servers and other equipment described and illustrated herein.

The access control system 14 may be any device or system used to monitor and track admittance into a sports stadium, convention center, or other venue. The access control system 14 may comprise, for example, a turnstile, an entry pedestal, a pedestrian gate, a hand-held reading device such as a bar code scanner, or an intelligent scanning turnstile. In some embodiments of the invention, the access control system 14 provides admission information and other data to the venue management system 12 via the communications network 22 or another network. The access control system 14 may also communicate with ticketing companies and other third party systems over the communications network 22 or any other network. The “media” or “device” a user could use to enter the venue, present at the POS or at outside locations could be a ticket or any other media—bar code, magnetic stripe, smart card. It also could be a cell phone using near field communication.

The point of sale system 16 may be any system used by a venue to track sales of products and services in the venue. An exemplary point of sale system 16 may include one or more central servers 34 or other computers and a plurality of distributed point of sale terminals or registers 36 as illustrated. In some embodiments of the invention, the point of sale system provides information to and receives information from the venue management system 12 via the communications network 22 or another network. For example, as described below, the point of sale system may communication with the venue management system 12 to verify and update stored value associated with tickets.

The marketing partner systems 18 may be operated by one or more marketing partners or sponsors of the venue or an event being held at the venue. For example, the systems 18 may be operated by a grocery store, restaurant, bank, or other entity that sponsors or is otherwise affiliated with the venue or an event at the venue. The systems 18 may also be operated by entities with membership programs that are linked to programs provided by the venue management system 12. For example, the systems may be operated by one or more airlines with frequent flyer programs. Each marketing partner system may comprise any number of servers or other equipment that provides data to and receives data from the venue management system 12 via the communications network 22 or any other network. Although only one marketing partner system 18 is shown in FIG. 1, it is understood that any number of such systems may communicate with the venue management system 12.

The computing devices 20A-C may be any devices used by fans, ticket holders, and other venue patrons to access the venue management system 12 via the communications network 22 or any other network. For example, the computing devices 20A-C may be laptop computers, desktop computers, tablet computers, handheld gaming platform (i.e. Nintendo DS)or other personal computers. The devices may also include wireless phones, phone-enabled personal digital assistants, phone-enabled MP3 devices, phone-enabled handheld game players, phone-enabled tablet computers, or any other wireless communication devices. Each computing device 20A-C includes or can access an Internet browser and a conventional Internet connection such as a wireless broadband connection, a modem, DSL converter, or ISDN converter so that it can access the venue management system 12 via the communications network 22 or another network.

The communications network 22 is preferably the Internet but may be any other communications network such as a local area network, a wide area network, or an intranet. The system 10 may also include a wireless network 24 capable of supporting wireless communications such as the wireless networks operated by AT&T, Verizon, or Sprint. The wireless network may include conventional switching and routing equipment. The communications network 22 and wireless network 24 may also be combined or implemented with several different networks.

The present invention may also comprise one or more computer programs stored in or on computer-readable medium residing on or accessible by the venue management system 12 or other computer equipment. The computer programs may comprise listings of executable instructions for implementing logical functions in the computer equipment. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The above described computer and communications equipment 10 may be used to implement a patron portal that may be accessed by ticket holders, fans, ticket administrators (for example, a company that owns multiple tickets), and other patrons. The equipment 10 may also implement an administration portal that may be accessed by owners, employees, and other administrators of a sports team or venue. The patron portal and administration portal may be partially or wholly integrated or implemented with separate computer equipment and programs.

One embodiment of the patron portal permits ticket holders and others to create accounts and to store ticket identification information in the accounts. A ticket holder may access his or her account and associate a stored value with a ticket or other media so the ticket or other media may be used to purchase products and services in the venue. When the ticket is presented to a vendor in the venue and scanned or otherwise identified, a point of sale station 34, 36 communicates with the venue management system 12 to verify the stored value associated with the ticket and to update the stored value to account for the sale. The ticket holder may access the account at anytime and add additional stored value to the ticket, transfer stored value to other tickets, and otherwise manage the tickets in real-time and then instantly use the tickets with the changed stored value. Patrons can recharge their stored value account on a one-time basis or set up triggers to keep their account balance within a patron defined range. Other embodiments of the invention achieve these objectives in a paperless ticket environment with no “hard” tickets required.

A company or other entity with multiple ticket accounts may access ticket information for all of them in a single account so that all the tickets may be managed by one ticket administrator. For example, the administrator may assign a stored value to some or all tickets and may subsequently move stored value between the tickets as the tickets are being used at a venue. The system 12 also provides reports on how the stored value associated with each ticket was used.

The present invention allows venues to provide their own private stored value programs without paying per transactions fees or using existing credit card networks as Stored Value is used at a location (there will be a CC fee charge as the fund the account). The patron portal also offers patrons the ability to manage their stored value limits on a per game or per-ticket basis. For example, patrons can utilize the patron portal to set their accounts to automatically maintain certain stored value balances on one or more tickets to ensure money is always available on their account. An account holder and/or a venue can manage stored value limits with generic venue settings or manage by loyalty and membership levels. The patron portal even allows for a credit line for certain patrons with venue defined limits and billing cycles. Additional details of the patron portal are described below.

The venue management system 12 may also implement a membership program that provides rewards and other incentives that are directly tied to a ticket holder's attendance history, purchase history, spending pattern, social media activity or other behavior. For example, the system may receive information from the access control system 14 to track when patrons enter the venue and/or from the point of sale system 16 to track purchases in the venue and may then provide points, rewards, or other incentives based on this information. Venues can allow patrons to buy or sell points using their stored value account based on an exchange rate defined by the venue. This lets patrons to buy more points or sell accumulated points for additional stored value. Points can also be redeemed via integrated third parties including third party ticket systems, web malls, and shopping carts.

Patrons can access their accounts from the patron portal and check the status of their membership, set-up automatic renewals of their memberships and see what rewards they have been given by the venue or marketing partners. Patrons can also access coupons, manage ticket stored values, and perform other activities described herein.

The venue management system 12 also allows members to register and check-in at events. A member's membership ID can function as a unique member identifier that tracks all relevant member activities, including ticket purchases, ticket resales and transfers, event attendance and online and in-venue purchases. Membership cards can be issued in different media including RFID cards and bar coded or magnetic strip cards or may be provisioned in any near field communication (NFC) equipped device. The cards add value to teams/venues as well as patrons in multiple ways, including:
Members can “upload one or multiple event tickets to a membership card. Members can use cards (as opposed to tickets) to gain entrance to a venue, thus enabling true paperless ticketing.
Cards can be used as a payment mechanism at concession stands and shops, to allow organizations to create a cashless venue environment.
Cards can be used to pay for products/services offered by the venue's co-branding and co-marketing partners.

The administration portal of the venue management system may implement a rules engine or other process that may be used to create rules, rewards and incentives and that allows an administrator to tailor rewards and other incentives to particular behaviors. For example, an administrator may create a rule that tracks all ticket holders that arrive in a venue before a particular time and then automatically assigns a stored value (e.g. $5.00) or a free product (soda, hot dog, etc.) to the tickets of these ticket holders to encourage patrons to arrive at an event early. The system also allows an administrator to provide stored value rewards for in-game events. For example, the rules engine may be configured to provide all patrons stored value and/or a free product if a home team scores a particular number of points or performs some other activity or may reward certain patrons (e.g. all those sitting in section A) upon the occurrence of some event. The rules engine allows venues to define the time and amount of rewards and enables complete automation of the rewards. More details of the rules engine are described below.

The venue management system 12 also allows a venue to offer coupons and other incentives from marketing partners. For example, the system may permit patrons to convert expiring stored value into a coupon redeemable for future ticket purchases. The coupons may be associated with a patron's account so they can be accessed and printed or may be associated with patron's ticket or membership card so the ticket or card can be presented to the marketing partner for discounts. In addition to converting to a coupon, the value or expiring value could also be automatically converted to a good or service. For example, a patron may be prompted to “click here now” to have a product mailed to them, or “click here now” to provision their phone to be “read” at a retailer to receive a free product. The system also offers a logic engine to control the manner in which coupons are electronically redeemed if there are overlapping offers.

The venue management system 12 may also allow patrons to link their accounts with other membership programs and to swap points and other rewards between the programs. For example, a patron may link his or her account to a frequent flyer account and swap points between the accounts at some pre-determined exchange rate. Patrons could also swap points for a service or product directly. (i.e., 1000 venue management account points can be swapped for a flight anywhere in the domestic USA)

The venue management system 12 permits a venue to define an unlimited amount of memberships and tiers for ticket holders and other users. Season Ticket Holder, VIP, Family and Senior are some examples of memberships that can be defined. Memberships can be sold or granted to a patron for free.

The venue management system 12 also allows an administrator to set membership pricing, charge for memberships or renewals, structure business rules to allow for the earning or rewarding of memberships, tiers or status or allow for the automation of these processes. Memberships can also be set to have restrictions such as age restricted, age eligible, geographic restricted or geographic eligible.

Using the rules engine, a venue can define multiple rules and apply those rules to different membership types. The rules engine allows a venue the flexibility to create multiple incentives across all their memberships, to treat each membership separately, and/or to reward the best patrons individually. For example, the rules engine may be used to reward a free candy to all those with a Family membership, a free hot dog or hamburger to those with a Season Ticket Holder membership, and a free meal to those with a VIP membership.

The rules engine may also be used to reward ticket holders or members for in venue behaviors. For instance, with double points for attending a Tuesday night game; family members with a free drink or double points by coming in before 5:00 p.m.; gold members with $5 if the home team scores 40 points in a quarter; and all members with 10,000 bonus points for attending 50% of games.

The rules engine may also be used to reward members for out of venue activities, or a combination of in venue and out of venue activities. For instance, attend five in venue events arriving 45 minutes before the event start time and make five visits to a sponsor in a 60 day period and receive.

Similarly, the rules engine may provide different rule “triggers” for each membership type. For example, members of the Family membership may receive a free product or free stored value only if some event occurs (the home team scores), but members of the VIP membership may receive a reward for just showing up to the venue.

The venue management system 12 also helps venues track special events and which members are attending. Through the administration portal, the venue management system allows an administrator to set-up special events, control the number of events a member can attend, and provide for on-line registration for an event. The special events may include, for example, concerts, banquets, autograph sessions, etc. Special events can either be granted to a member or can be earned as a reward and automatically be granted to a member from the rules engine. Once members register for an event, the venue management system 12 may create an access control list that can be used by the access control system 14 of the venue to automate the entry for the event and report on who attended.

In addition to the membership programs described above, the venue management system 12 may also implement a loyalty program for patrons who do not sign up for a membership. The system allows a venue to create an unlimited amount of loyalty levels that can be used to provide automated or manual rewards to patrons. Loyalty accounts can be managed on-line by patrons and allow a patron to activate stored value, make donations or even upgrade to a membership.

As with the membership programs, the venue management system 12 permits a venue to define an unlimited amount of loyalty levels such as One Time Guest, Frequent Visitor, etc. The system also allows a venue to create multiple rewards programs that treat the loyalty levels independently of each other.

As with the membership programs, the venue management system 12 allows a venue to promote patrons from level to level within the loyalty program based on multiple criteria. Promotions may be based on spending, attendance, points accumulated, the amount of money donated or any combination of the above. Not only can a venue use the rules engine to define incentives for each level of loyalty, they can also define spending limits, stored value account maximums, expiring stored value times and even allow the establishment of a credit limit for periodic invoicing.

As with the membership programs described above, the venue management system 12 allows a venue to establish multiple rules for non-members in the loyalty program. An administrator may define rewards that apply to all levels or create rewards that are specific to a level. The rules engine provides the flexibility to automate and manage single or multiple programs. The system allows for non-members to be given free products, stored value, or other rewards even when the identity of these n on-members is not known. For example, the system may reward everyone in section 201 with a hot dog and then associate this reward with their tickets. See above for in venue/out of venue business rules

Patrons can access their loyalty programs from the patron portal to see what rewards they have earned, what is needed to advance to the next level, buy points to increase their standing, sell points for stored value or transfer points to marketing partner programs.

The venue management system 12 may also implement a fundraising program that permits a venue to accept donations and allows patrons to set-up defined amount donations or lump sum payments. The donations may be made by patrons from the patron portal. The patron portal allows fans to donate one-time lump sum or defined donations or to set-up payment plans that provide automatic donations to the venue on a set schedule. If there are multiple donation programs in place at a venue, the venue management system 12 allows the patron to pick which program receives their donation.

Memberships can be established by a venue to rewards those patrons who donate to the venue or its programs. Memberships can be based on the amount of funds donated. The rules engine allows a venue to define specific rules based on the membership.

Donations can also be accepted by a venue via the administration portal. This allows ticket sellers and call center personnel to accept cash or credit donations from anywhere with web access.

Donations can also tie into the loyalty program and allow for a venue to not only offer multiple memberships but to also offer loyalty levels within that membership. The system's flexibility offer venues the ability to define multiple membership and reward structures to truly maximize its reach with patrons.

The rules engine allows a venue to create custom reward rules to incentivize and reward patrons for their donations. Rules can be established not only by membership and/or loyalty level but even for one-time donations.

The system also allows an administrator to reward patrons with access to special events based on their donations. The rules engine may grant access to these special events, and the venue management system handles the event registration and reporting of attendance as explained above.

The venue management system 12 also allows patrons to define what information is shared to their friends and families via their existing social networks. Patrons can configure Facebook, Twitter, or Google+ account information, and the venue management system 12 will post relevant information to their accounts. The venue management system 12 also allows patrons within a venue or a membership or loyalty program to link to each other. Patrons that link within “Venue Social Friends” will receive more detailed information directly posted to their accounts when a linked friend has activity. This drives additional awareness of programs, donations and marketing partners using patrons' social networks. This also allows a venue to find out who its most influential patrons are in the world of social media. The system will allow for a venue to reward for any type of social media activity (i.e., liking a page, opening an email etc.)

A patron who configures their account via the patron portal to interact with Facebook will have the option of posting the following information to their wall: Promotion Details, Reward/Benefit Details, Donations, Donation Amounts and Seating Information.

A patron with a configured twitter account will allow the venue management system to automatically tweet for them the following information: Promotion Details, Reward/Benefit Details, Donations, Donation Amounts and Seating Information.

If a patron has a linked Foursquare account, the venue management system will automatically check them in at the venue upon scanning of the ticket at the entrance to the facility.

The venue management system 12 also allows for members to link to each other directly. Upon linking to each other, the system will automatically post to both the users' Facebook wall and to their linked friend's Facebook wall the following information: Promotion Details, Reward/Benefit Details, Donations, Donation Amounts and Seating Information. The venue can also define messages that are sent.

The venue management system 12 also allows for a venue to offer coupons to patrons who are registered for a membership or participating in the loyalty program. Coupons generated by the system may have a barcode or may be associated with a ticket. Coupon barcodes can be randomly generated or given a static number. Coupons may include a discount or coupon code depending on the retailer or marketing partner the coupon is going to be used with. Coupons can also be grouped into an e-book for a single rule to distribute multiple coupons (e.g. a Six Flags Season Pass Holders Coupon Book). Coupons redeemed electronically may also be filtered to define which coupon applies in any instance if multiple coupons are available. Coupons may be configured via the administration module and may consist of the following information:
Coupon Name: The name of the coupon.
Coupon Description: Description of what the coupon is good for. The description also shows up on the printed coupon and in the patron history.
Valid Dates: The range of dates for which the coupon is active.
Active box: Check box used to enable/disable the coupon.
Email/Print/Kiosk Boxes: Check boxes used to control how the coupon can be distributed or used by the user. Removing a check from the box disables the functionality. The kiosk box is used for integrations with third-party POS systems or out of venue locations with a kiosk.

The venue management system 12 may also be used to link patrons with marketing partners. For example, a patron may select which official partner they would like to link to and enter in their account number for the partner program. Once a patron is linked to a marketing partner, they will have the ability to swap points back and forth between the venue and the marketing partner's loyalty program. Marketing partners are set up in the administration module and allows for the establishment of a points-to-points/miles exchange rate between systems. Once a marketing partner is integrated, the patron portal will have a “Transfer Points” button appear on a Points tab.

The rules engine described above will not be discussed in more detail. The rules engine allows an organization to define rules that reward members, loyal patrons, and donors. The rules engine allows for a multitude of triggers and the ability to reward patrons with multiple incentives. The rules engine may automatically provide rewards and other incentives based on triggering events or an administrator may manually provide rewards to particular accounts or tickets. Once a reward is generated for a patron, it will appear on their account. Patrons can then use their ticket, an RFID card, drivers license, or any other identifier that is associated with their account to access the free stored value or other items given with the reward.

In some embodiments, the rules engine may implement three reward types: automatic, manual and batch. Automatic rules provide rewards automatically upon the scanning of a ticket or a defined threshold being reached. Manual rules are typically used for the promotion of in-game events or unplanned incentives and are executed from the administration module by selecting the rule and then telling the venue management system to execute the rule. Batch rules are used on a nightly basis for the automation of promotions, processing of payments, renewals and granting of rewards that are not time sensitive.

The rules engine allows an administrator to provide an explanation for a rule, and this explanation will then appear on the account of each patron that is rewarded by the rule.

The rules engine allows an administrator to establish who the rule will apply to when it is executed. This allows for inclusion and exclusion by membership or loyalty level to prevent “double rewards” and can also apply to all patrons visiting a venue. The rules engine also tracks when a rule has been applied to an account and will not re-apply the same rule to the account if the rule is implemented again.

Rules can also be set to run for a specific event, a specific day, and even a specific time in a day. For example, the rules engine also allows an administrator to specify a date range for a rule.

The rules engine also allows an administrator to establish a rule that applies to the venue or to an out of venue location such as a retailer or other integration.

The rules engine allows for an administrator to define the trigger or other criteria to cause a rule to be executed. Examples of triggers include:
Entry Time—a timed period of entry to a venue for which the rule is valid.
Events Attended—the numbers of events a patron is required to attend to cause the rule to execute.
Spends—a set amount of dollars spent to cause the rule to execute.
Products—if a specific product is purchased a reward is given.
Points—a set amount of points that must be accumulated to execute the rule.
Seat Location—a rule based on where a seat location is. Rule can be by section, by row number, by seat number or any combination of the three.
None—a rule may be executed that requires no pre-defined limits to be met.
Donation—a rule based on the total amount of money donated by a patron.
Discount Code/Buyer Type—a rule based on the discount or buyer code from the ticketing system when a ticket is scanned.
Social Media: Generic reward for accounts that meet certain criteria (i.e. opened 5 email, made 6 posts, liked a page.)

The rules engine also allows an administrator to define what reward or benefit is given to a patron who qualifies for a rule when it is executed. Multiple benefits or rewards can be granted per executed rule. For example, a free product based on a specific SKU, stored value, points, coupons, access to a special event, etc. may be assigned to a ticket or a patron account upon execution of a rule.

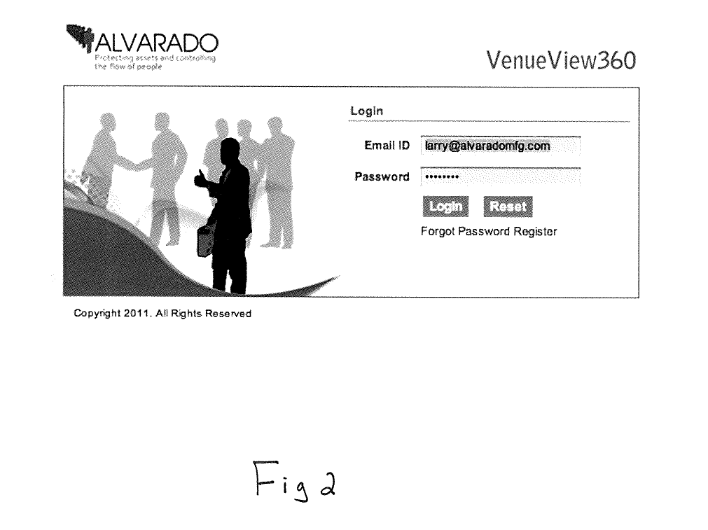

An embodiment of the patron portal described above will not be described in more detail. As discussed, the patron portal allows patrons to quickly and easily view and manage their accounts. The patron portal can be accessed by any patron with one of the computing devices 20A-C illustrated in FIG. 1. Patrons can also register to become members within the patron portal. Sample screen displays of an exemplary patron portal are shown in FIG. 2-20.

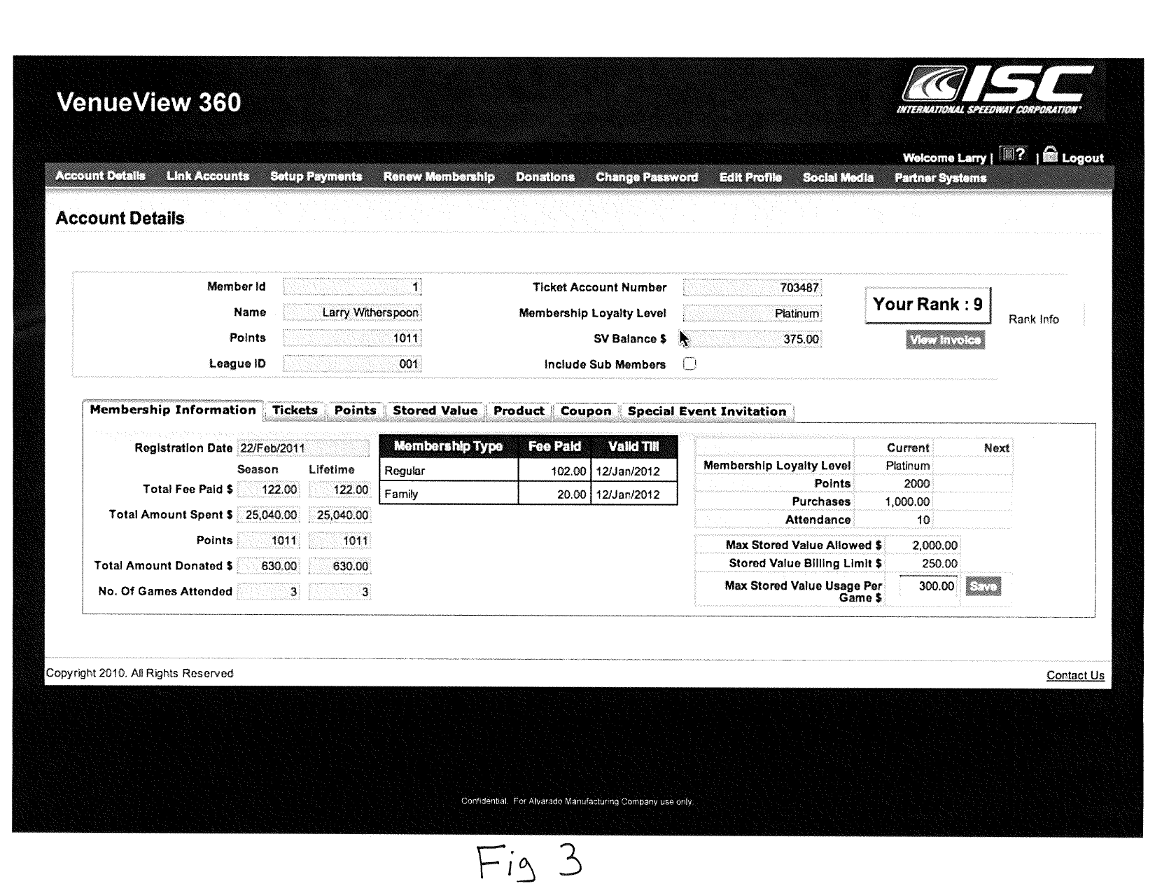

An account holder may access their account by launching the portal with the appropriate URL and then entering log-in information on the screen shown in FIG. 2. Once logged in, the venue management system 12 may display a main page such as the one shown in FIG. 3. The main page may include an Account Details tab that displays the following:
The patron's name or account name.
A ticket account number provided by the ticketing provider.
Indication of the patron's loyalty level.
The number of points the patron has accumulated.
The amount of stored value or other money associated with the account.
The patron's membership I.D. number for the venue's membership and/or loyalty programs.
The patron's League I.D. or other membership number for a league or organization membership or loyalty program if one exists.
A Sub-Members Box, which if checked, will display ticketing, stored value, points, coupons and special event invitations for any account linked via the “Link Accounts” or Managed Accounts” functionality.

The main page may also present a “summary” or “Membership Information” tab that lists a patron's year-to-date and lifetime spends, donations and point accumulations as shown in the bottom half of the screen of FIG. 3. This page also shows which memberships the patron has, the valid dates of those memberships, and current loyalty level and next loyalty level requirements. From this screen, patrons can override the stored value default value, default values and other values.

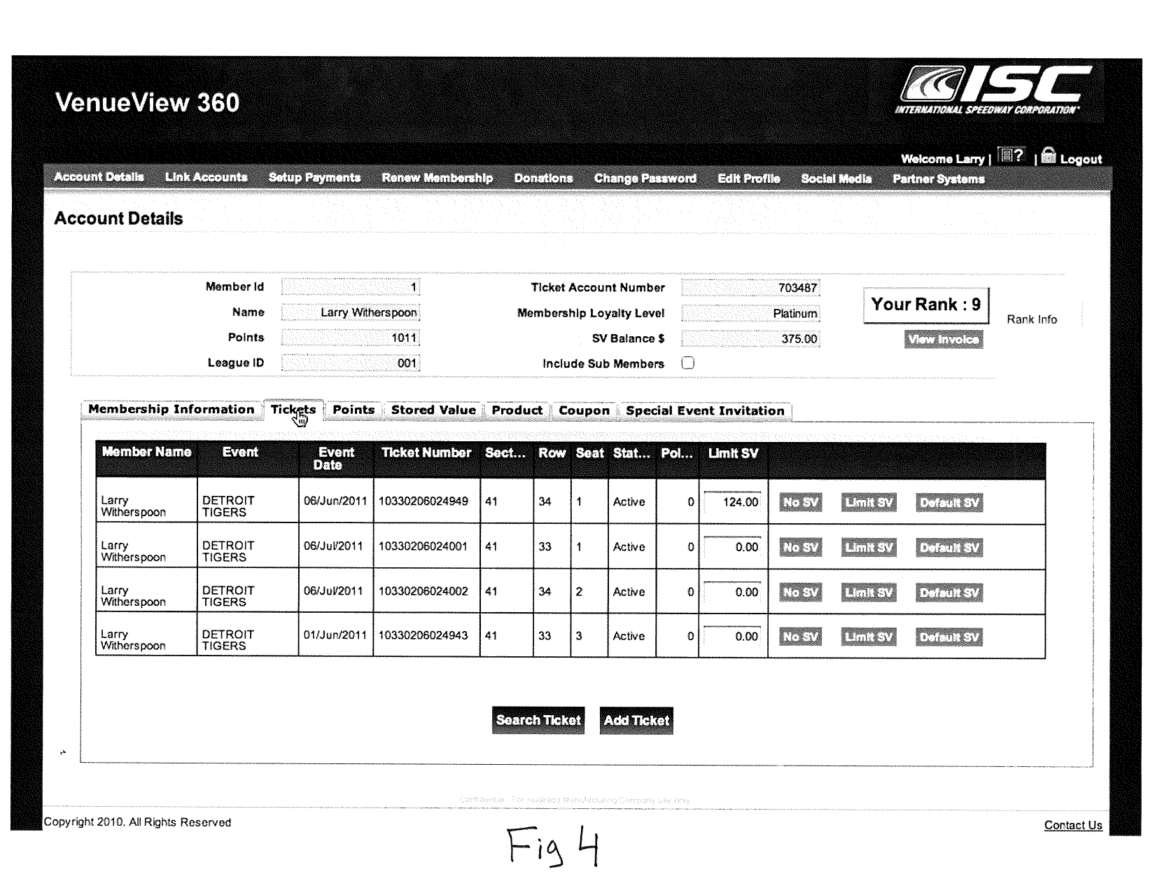

The main page may also present a “Tickets” tab that links to a screen shown in FIG. 4. This screen provides a listing of all tickets on the account. This screen allows for per ticket stored value limits to be established or for stored value to be disabled for a specific ticket. Tickets can also be modified on a by-event basis so simple changes can be applied to all tickets for an event without having to deal with each ticket individually.

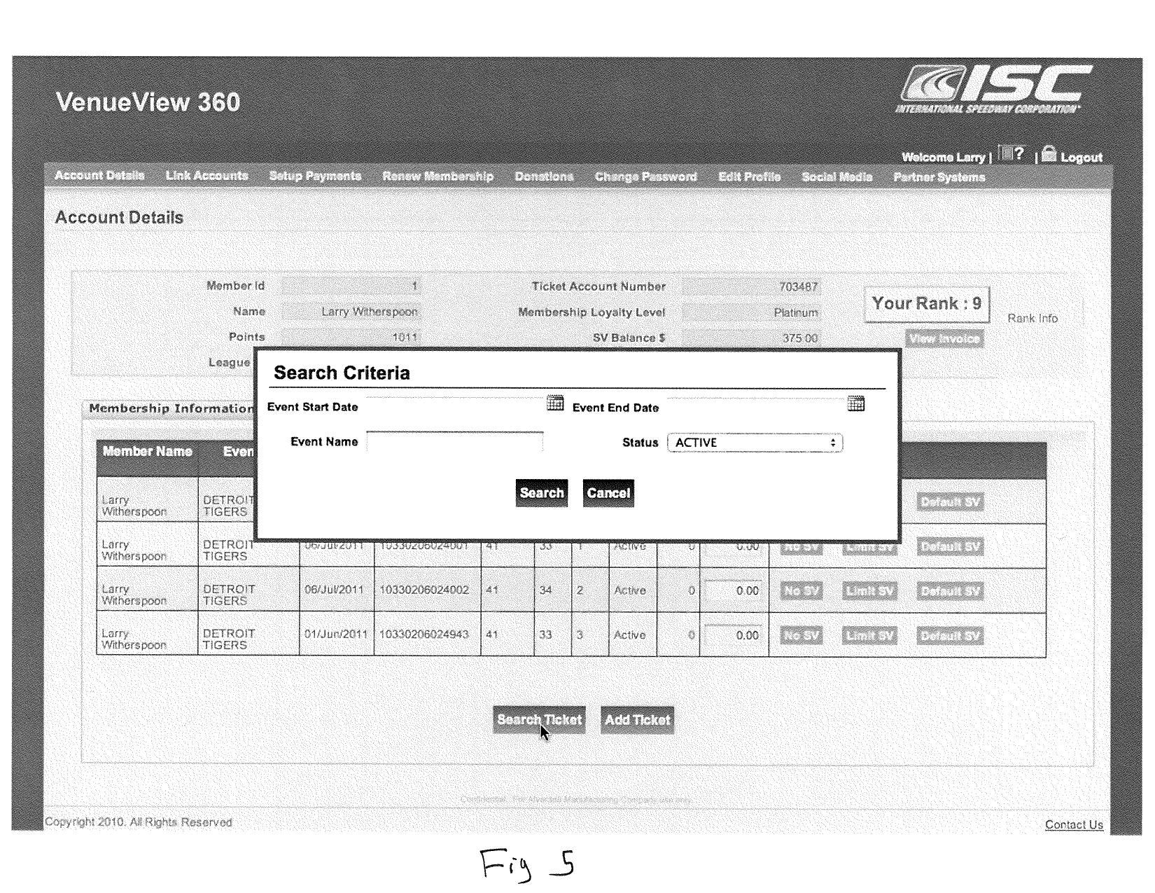

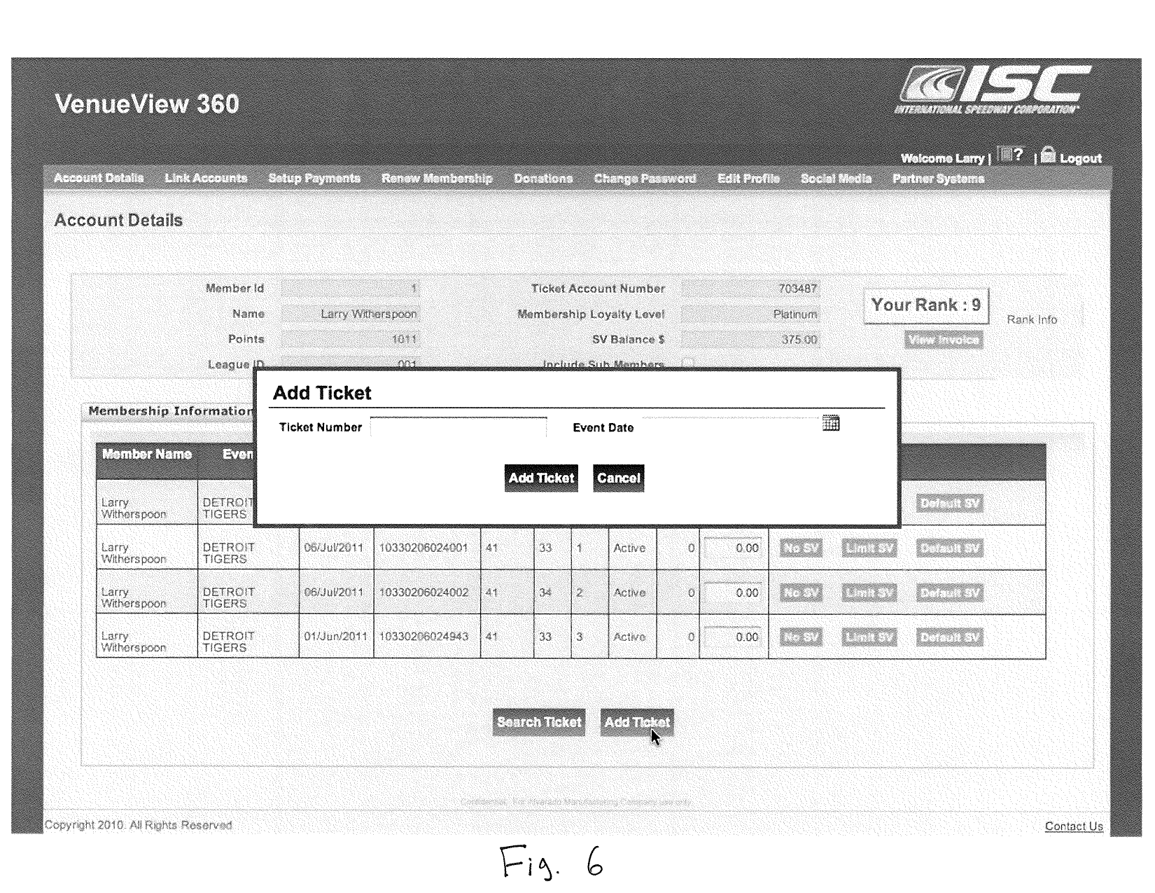

A ticket search function shown in FIG. 5 allows for all of the tickets to be searched by status, date or event. Patrons who are members but bought a “quick sale” ticket at an outlet or window also have the ability to add a ticket to their account as shown in FIG. 6 in order to receive the benefits of attendance.

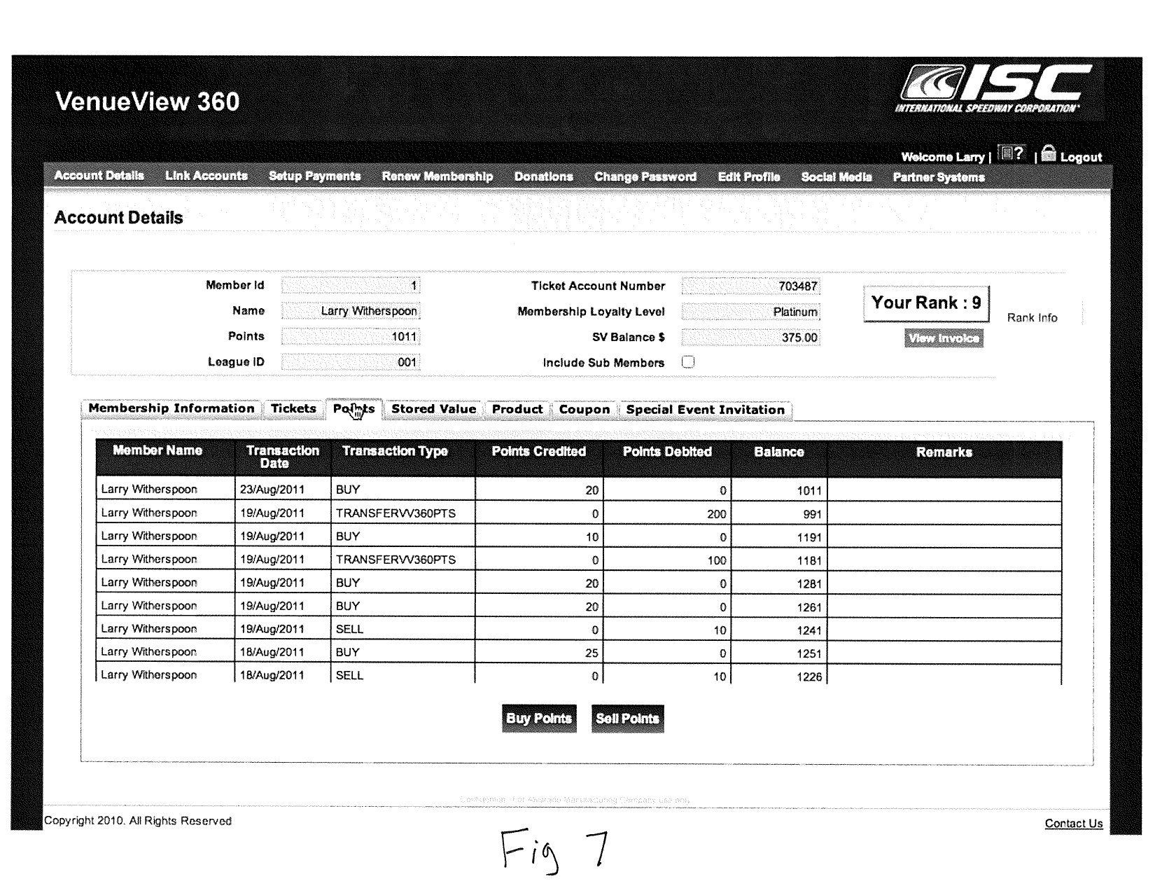

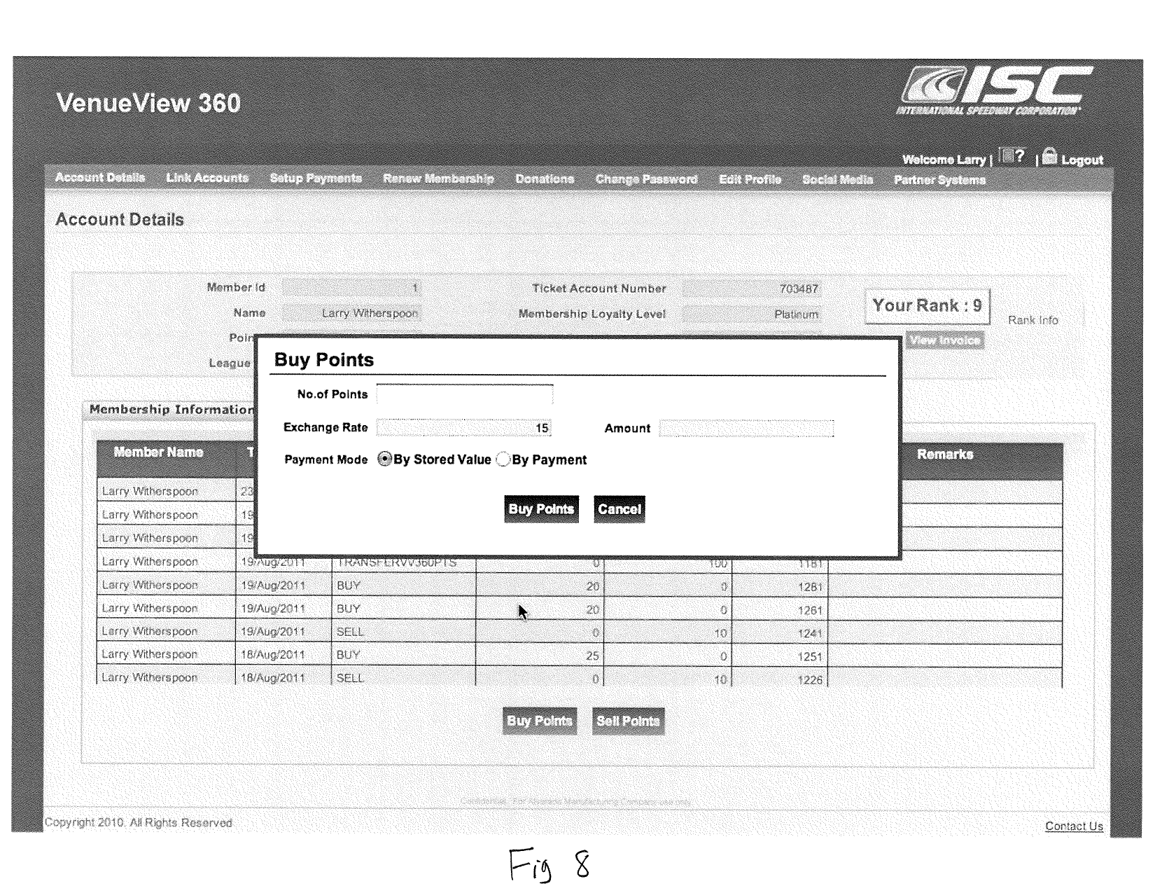

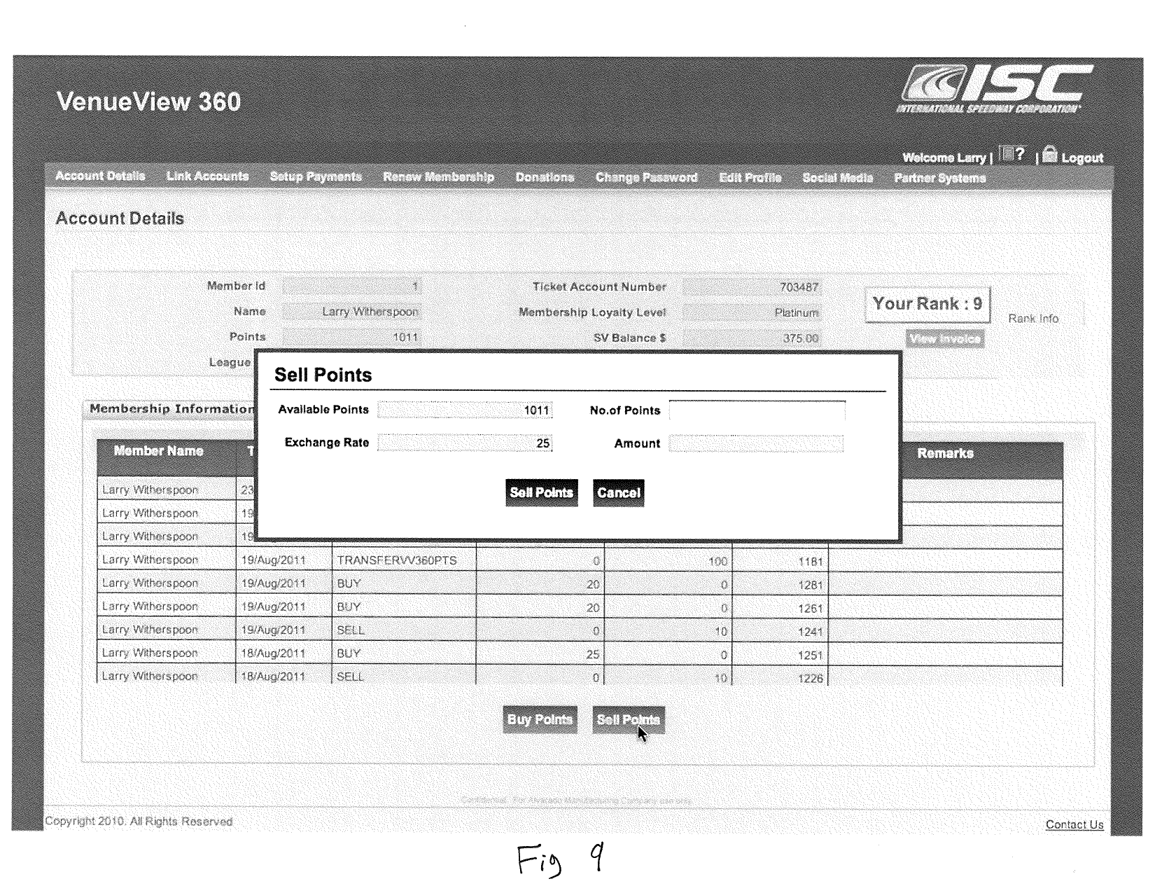

The main page may also present a “Points” tab that links to a screen shown in FIG. 7. This screen allows a patron to see their point history, buy points via stored value or credit card, sell or exchange points for stored value, or transfer points to a venue marketing partner as shown in the screens of FIGS. 8 and 9.

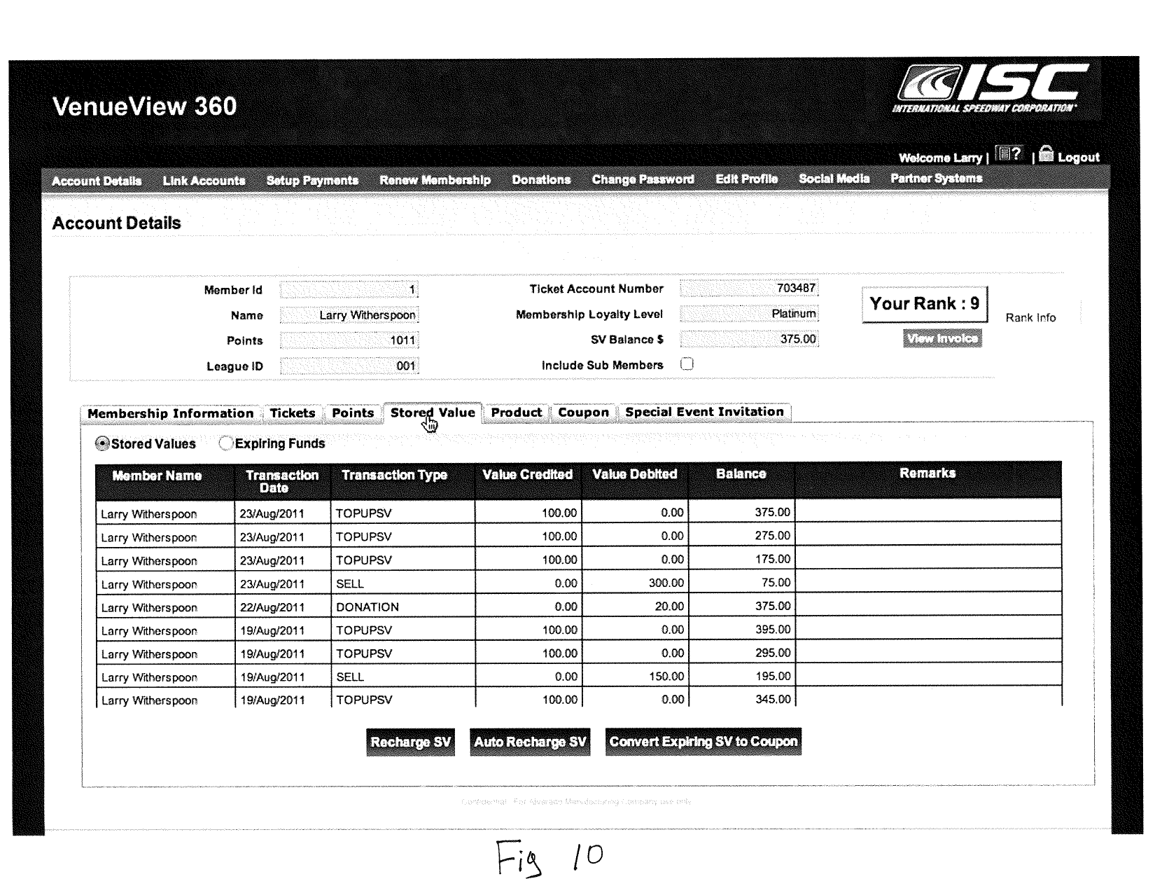

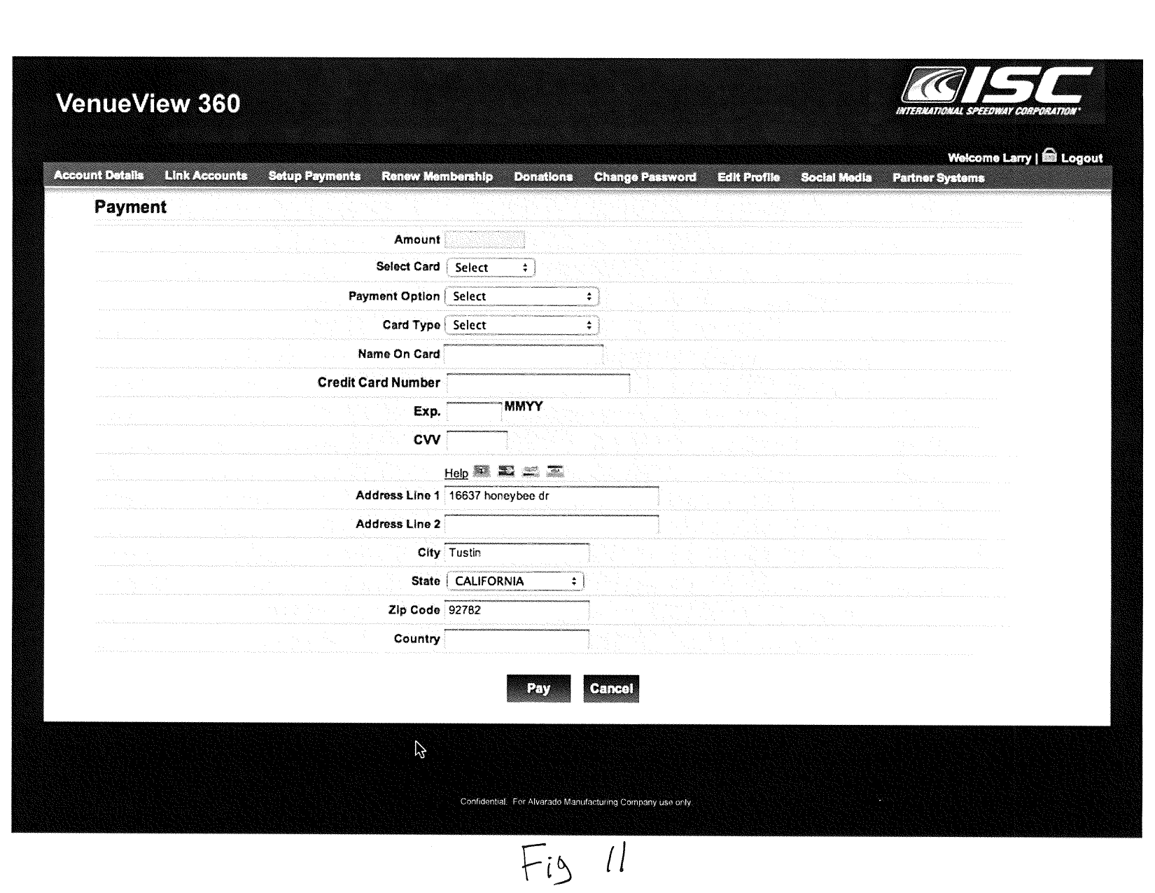

The main page may also present a “Stored Value” tab that links to a screen shown in FIG. 10. This page allows patrons to see their stored value history, monitor expiring stored values, recharge their stored value, and convert expiring stored value to a coupon. Stored values may be paid for by credit card as shown in FIG. 11 or by another means.

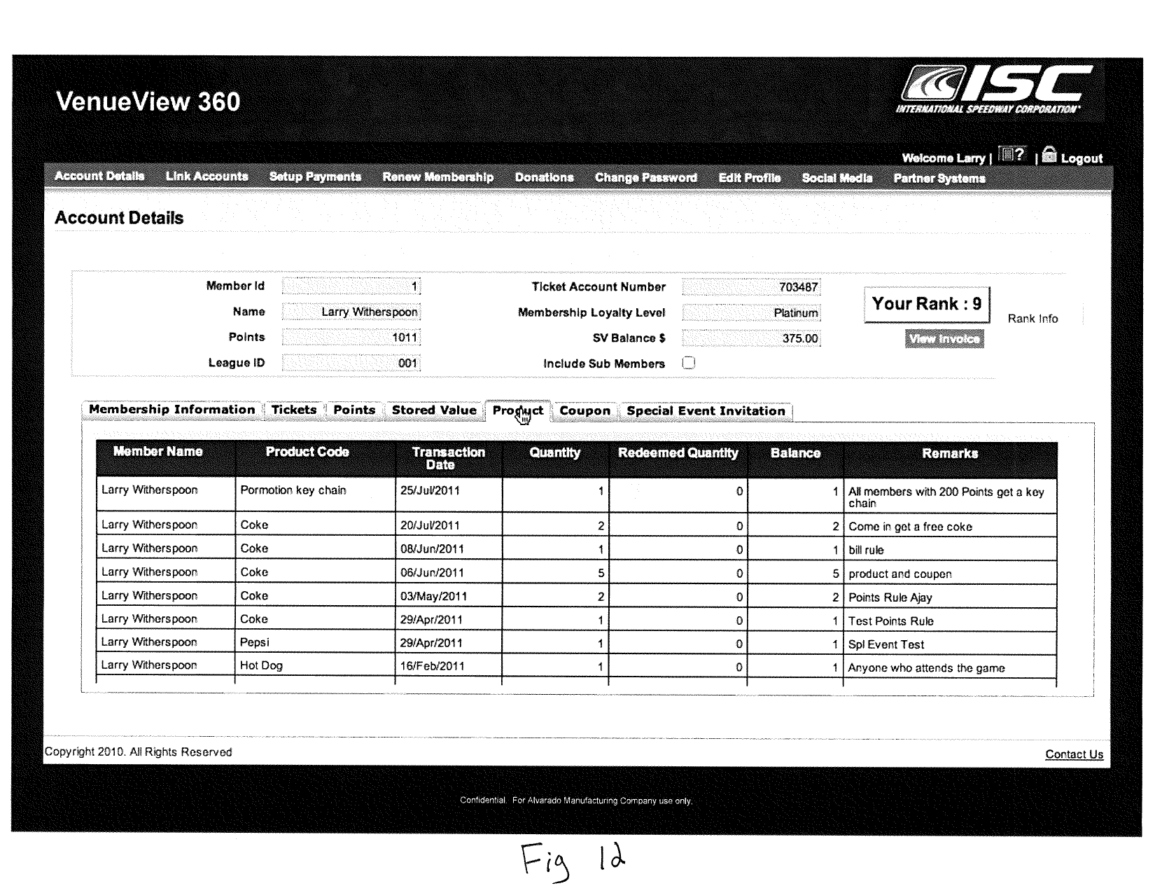

The main page may also present a “Product” tab that links to a screen shown in FIG. 12. This screen lists all products that have been associated with the patron's account or tickets and the purchase status of these products. Products are also redeemed electronically, filtered for appropriate use and automatically credited during a transaction.

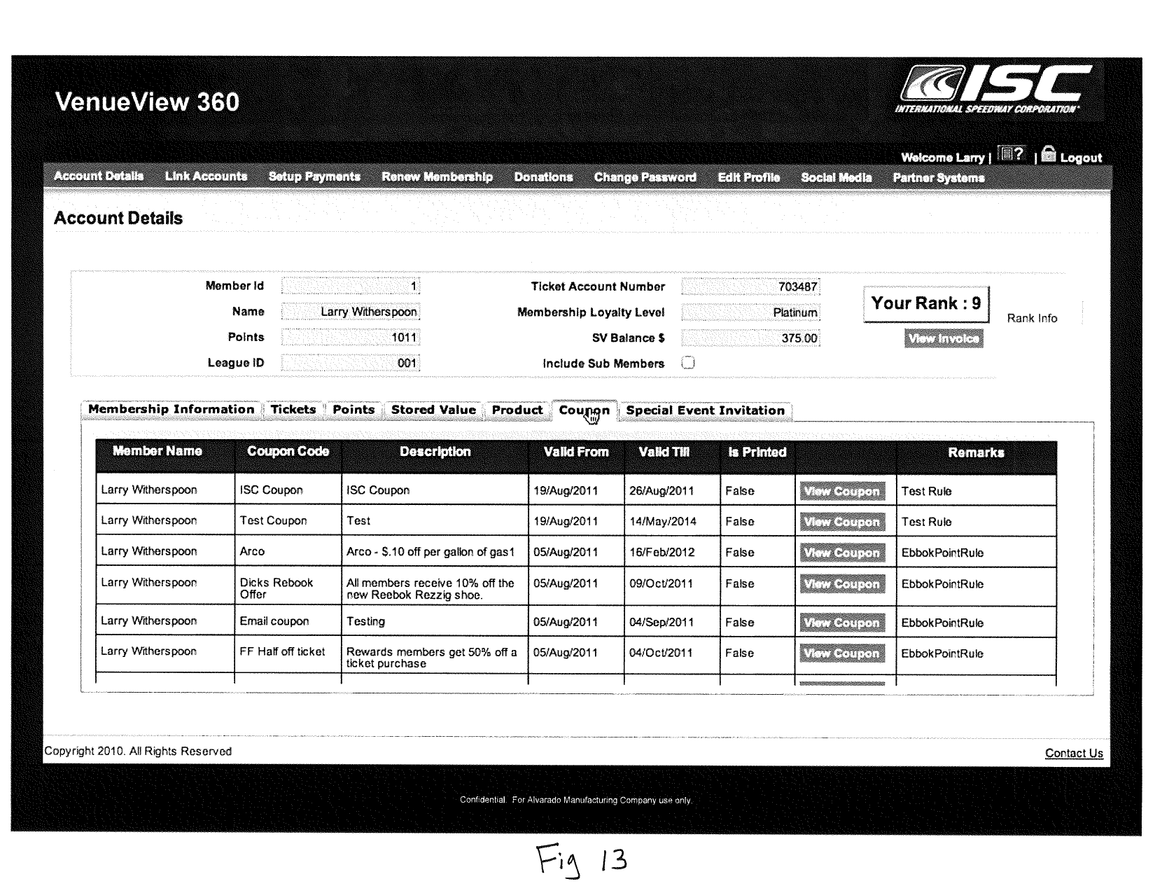

The main page may also present a “Coupon” tab that links to a screen shown in FIG. 13. This screen provides listing of all coupons that have been awarded to the patron and the status of the coupons. If eligible, a ticket or coupon can be printed, texted or emailed from this page.

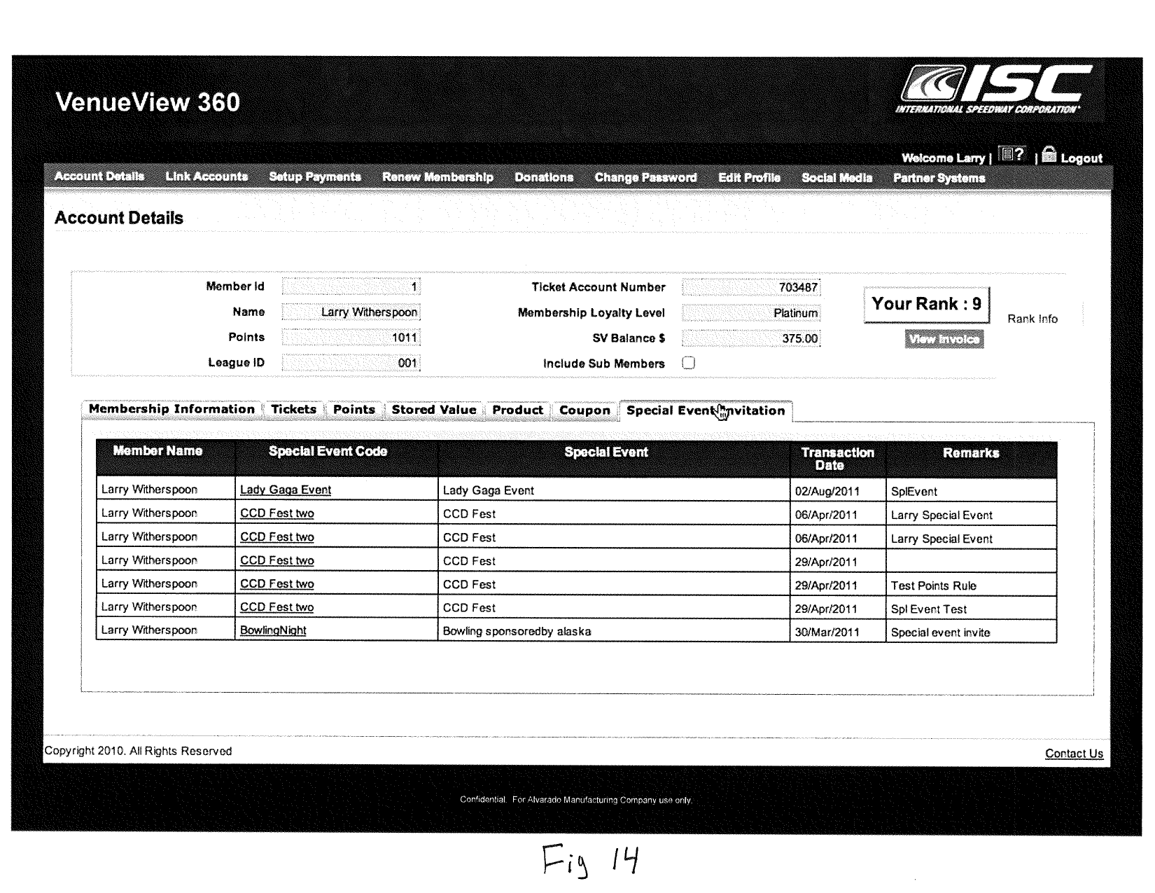

The main page may also present a “Special Event Invitation” tab that links to a screen shown in FIG. 14. This screen provides a list of any special events to which the patron has been invited. A patron can click on an event and then register to attend it.

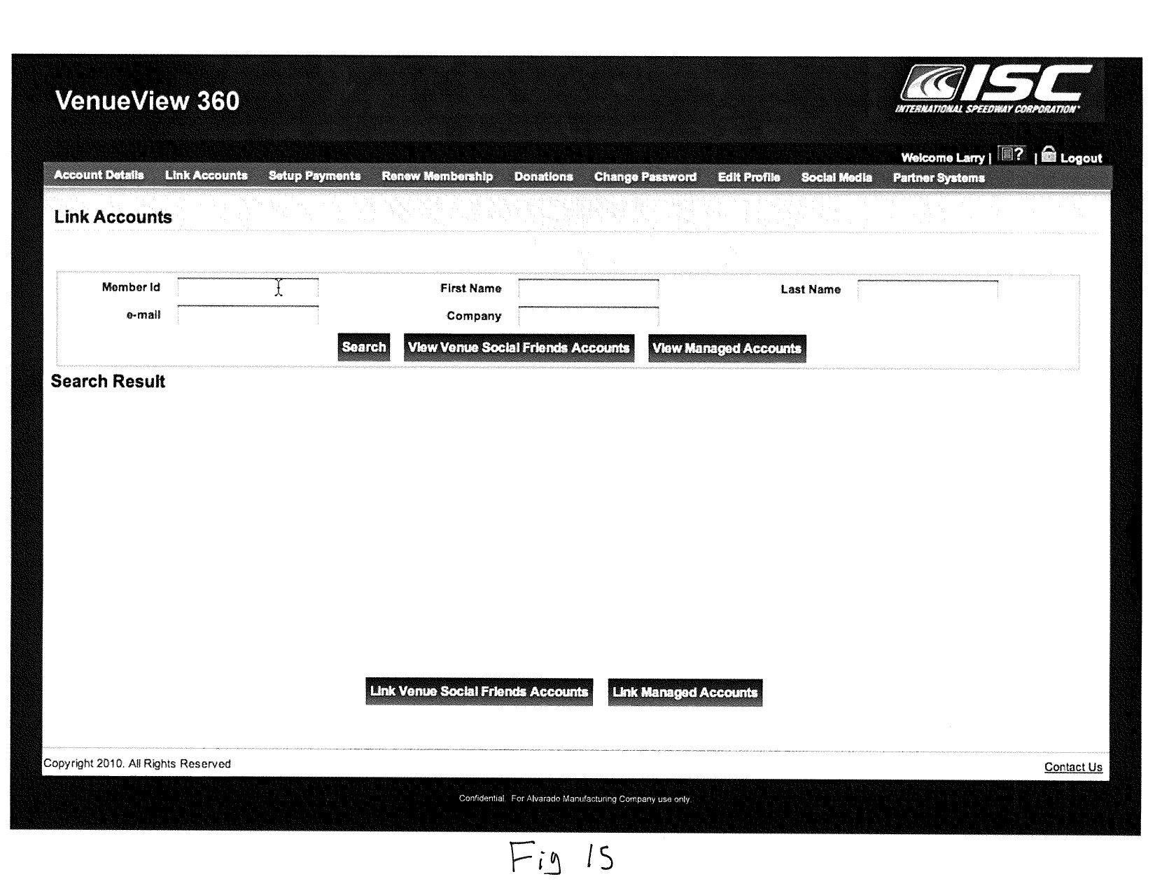

The main page may also present a “Link Accounts” tab that links to a screen shown in FIG. 15. This allows members to link to each other in two distinct ways: A Venue Social Friends feature allows patrons with configured Facebook, Google+ or Twitter accounts to be linked and share information about their activities at the venue. A Managed Accounts feature allows for the management of multiple accounts from a single master account and login. All accounts that request to be linked must be approved by both parties.

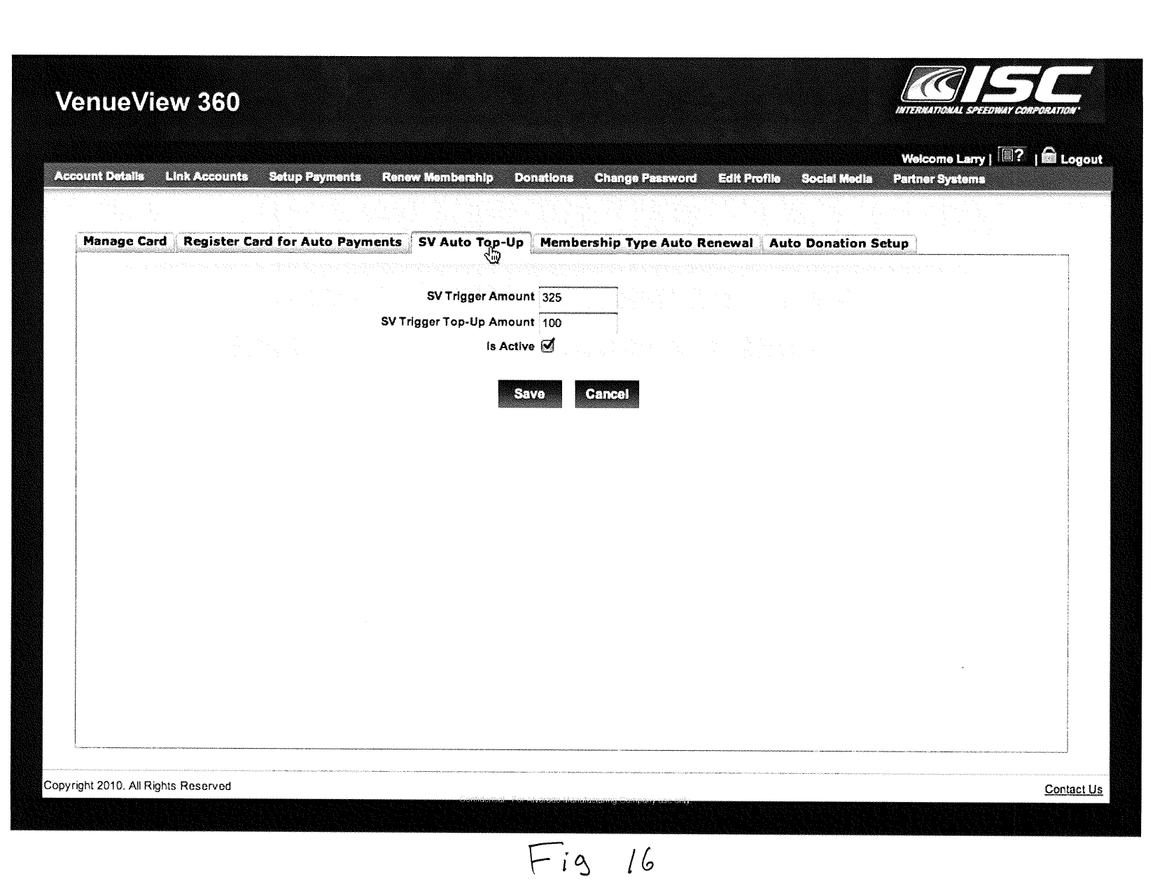

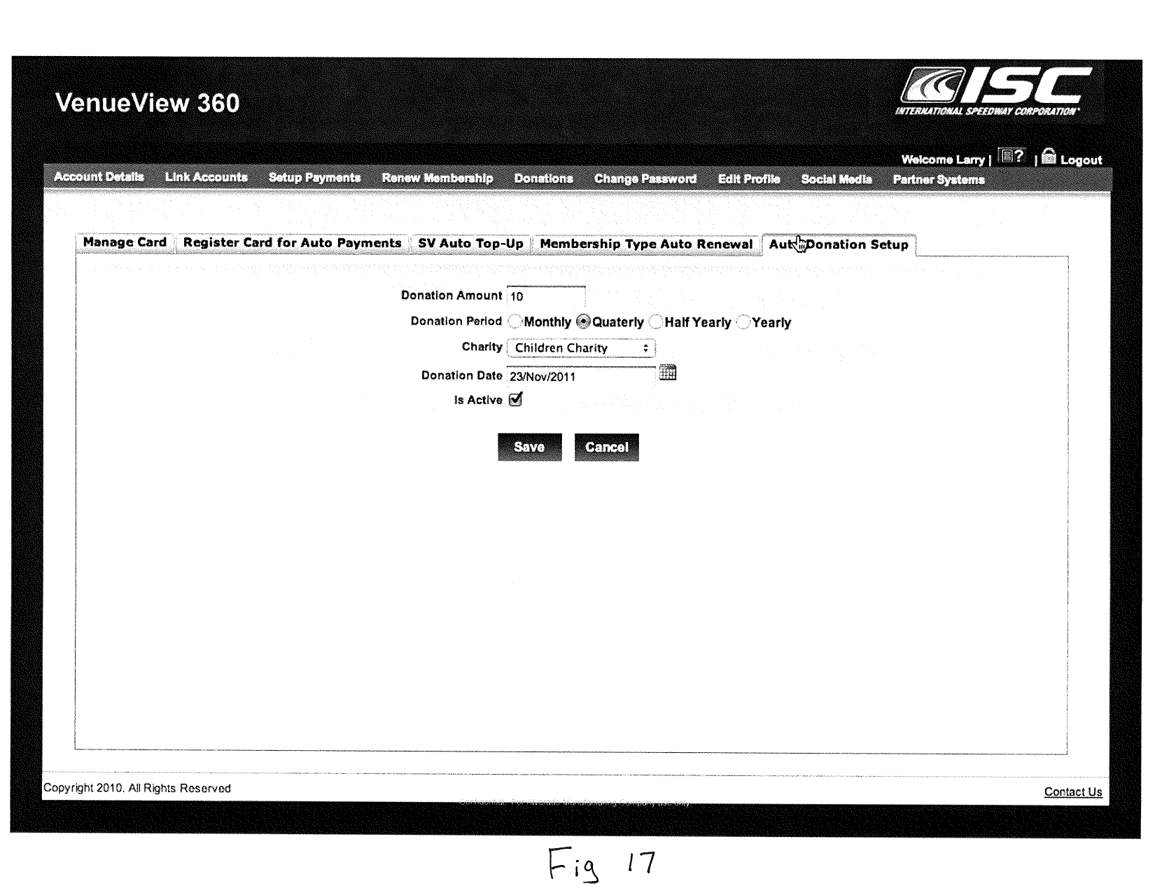

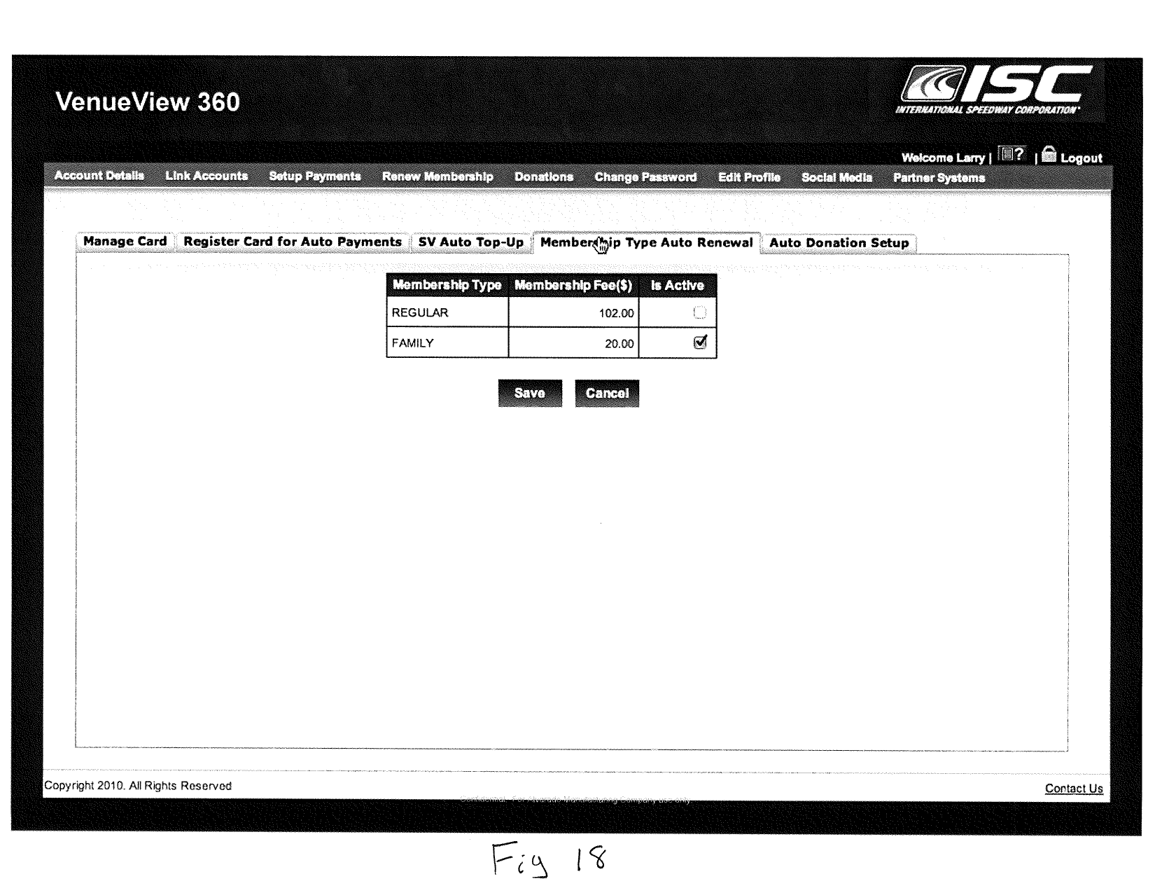

The main page may also present a “Setup Payments” tab that allows patrons to manage their financial information. Patrons can establish stored value auto-top limits to make sure they always have money on their account as shown in FIG. 16, set-up automatic payments plans for donations as shown in FIG. 17, and set their memberships to auto renew as shown in FIG. 18. Patrons can also register multiple credit cards and select which credit card they would like to be in use at any given time.

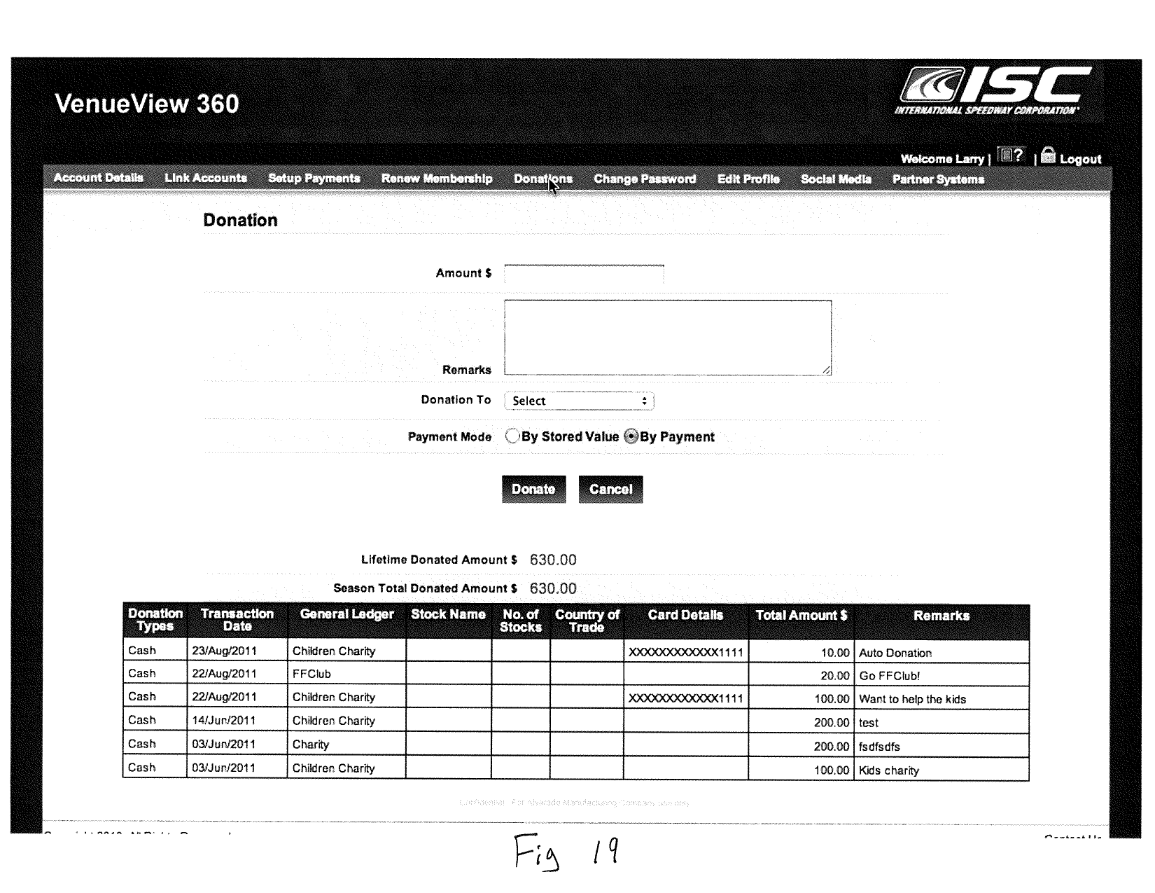

The main page may also present a “Donations” tab that links to a screen shown in FIG. 19 that allows patrons to see their donation history, give a one time donation, or establish a donation payment plan for periodic automatic donations.

The main page may also present a “Partner Systems” tab that allows a patron to select an approved venue marketing partner and link his venue loyalty program to the marketing partners program.

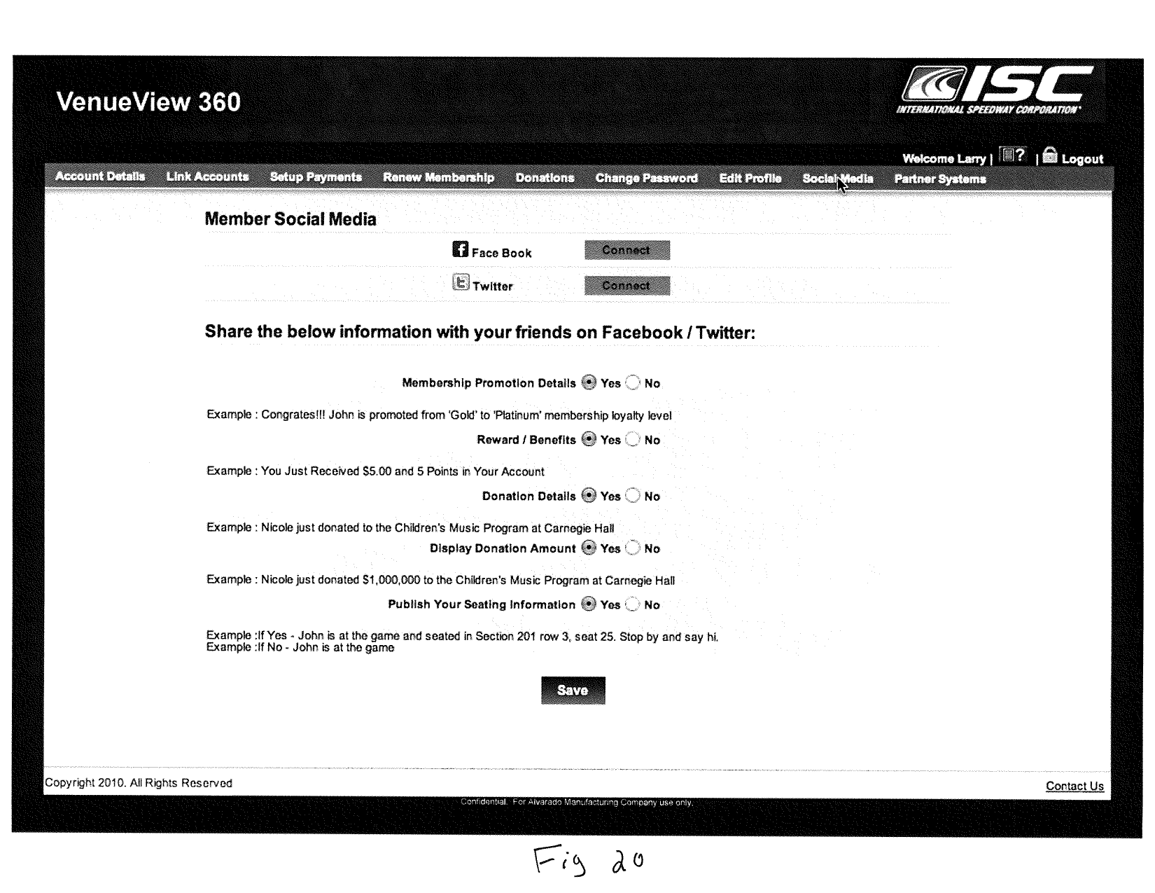

The main page may also present a “Social Media” tab that links to a screen shown in FIG. 20. This screen allows a patron to link to their Facebook, Google+ and twitter accounts and also select what information they wish to share with their social networks.

The main page may also present a “Edit Profile” tab that allows a patron to modify any information that is allowed by the venue. If a patron is allowed to change their information, then the system allows for the patron to modify their address, email, phone numbers and other personal information.

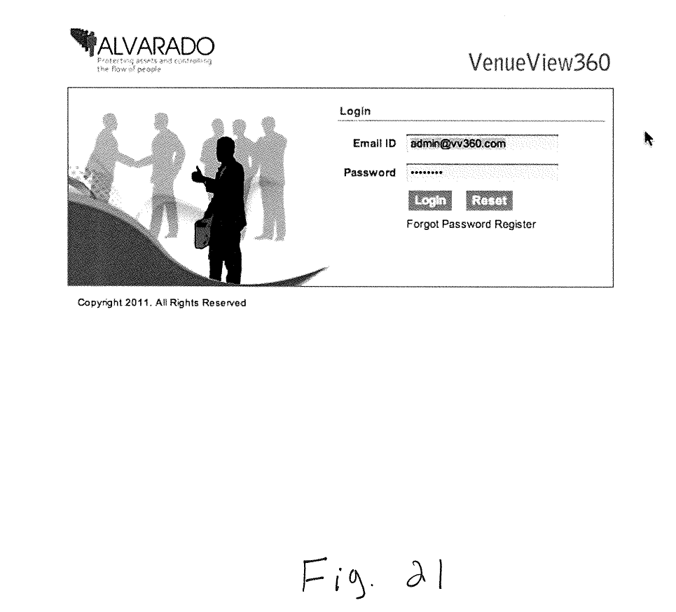

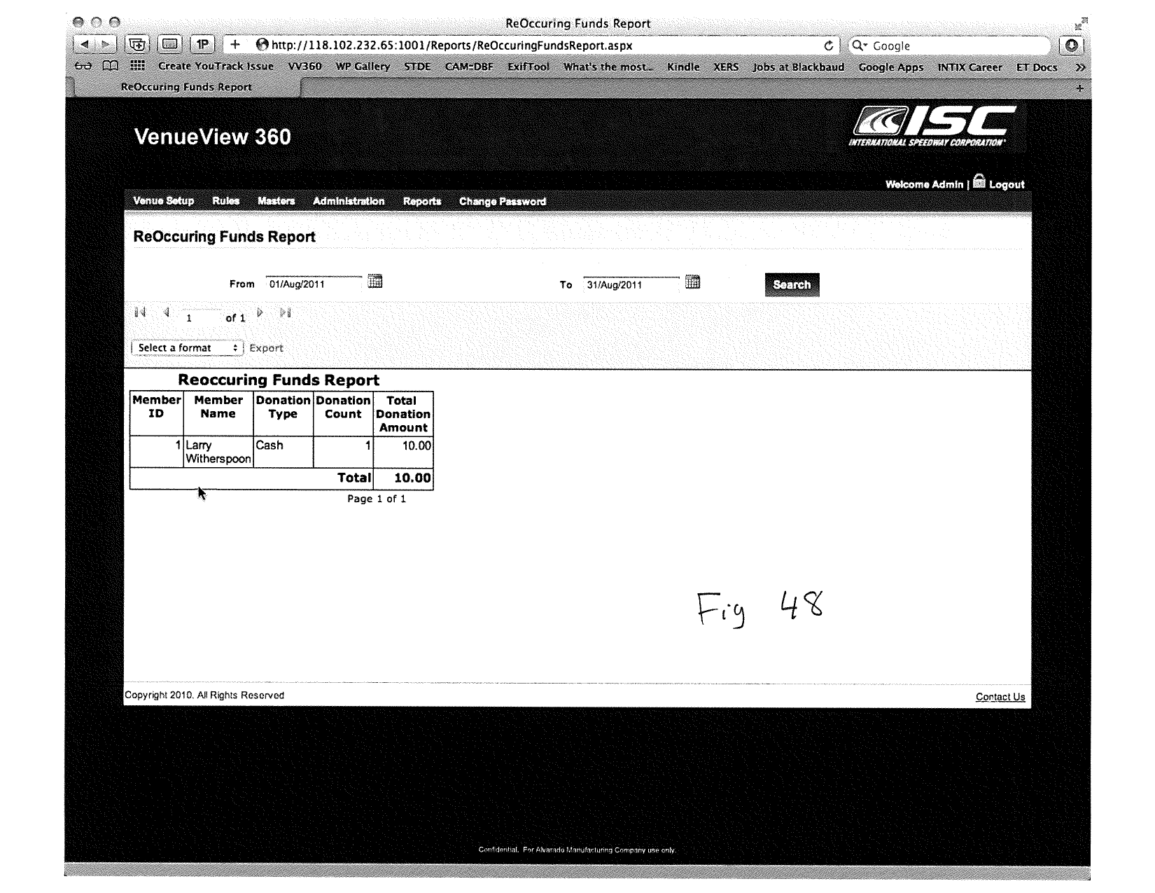

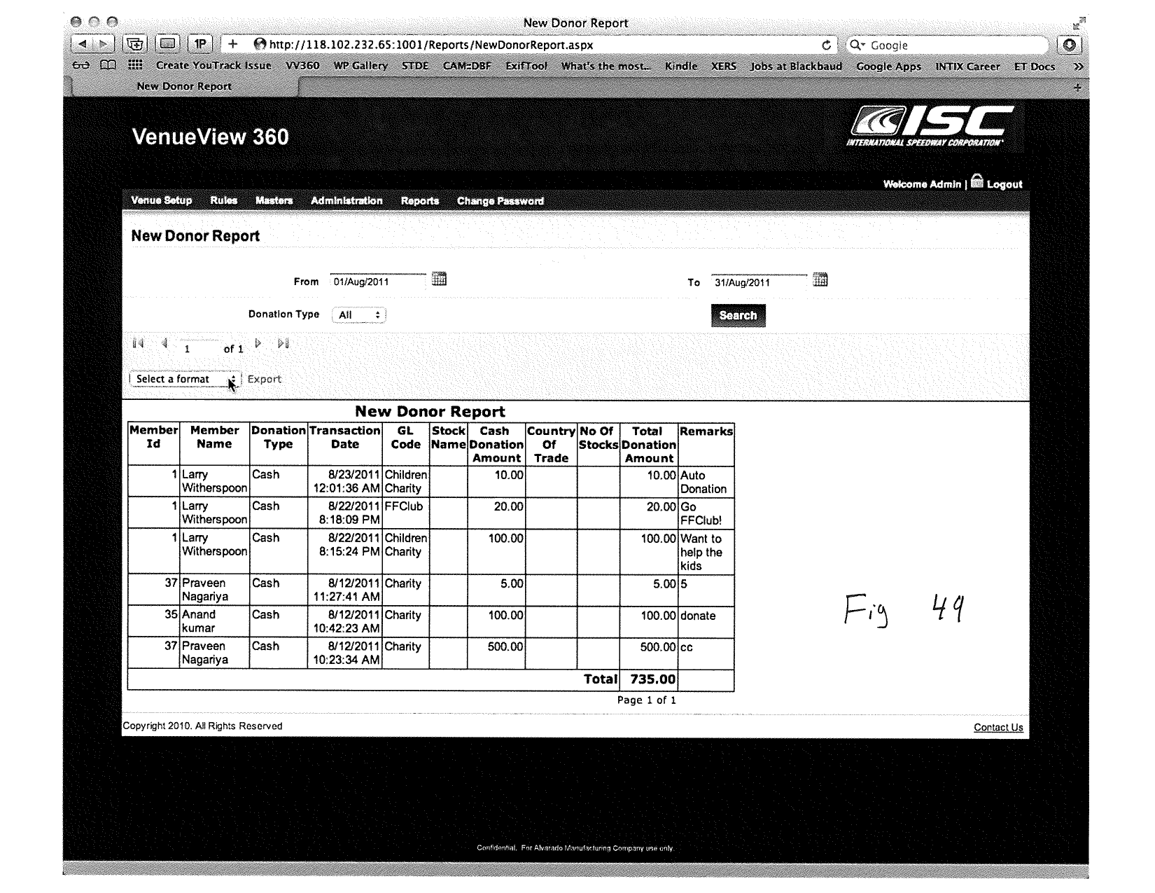

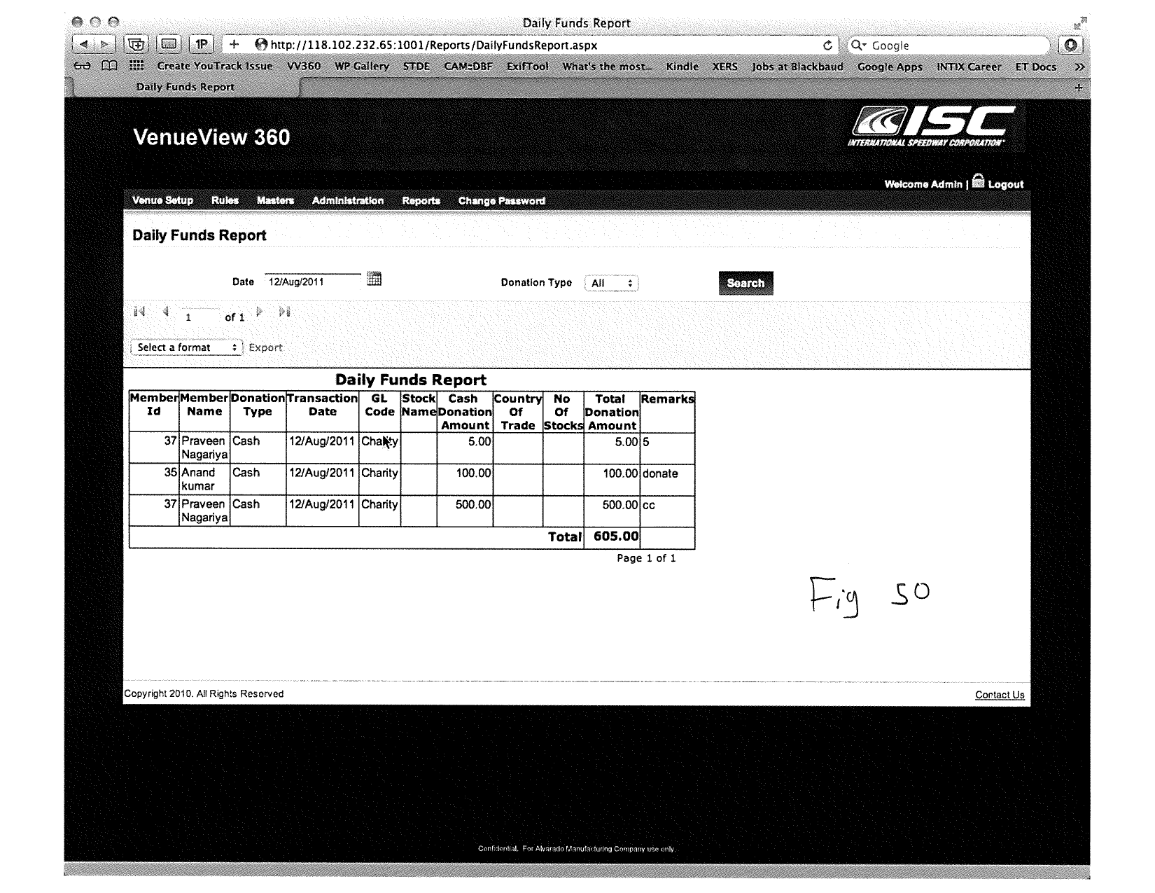

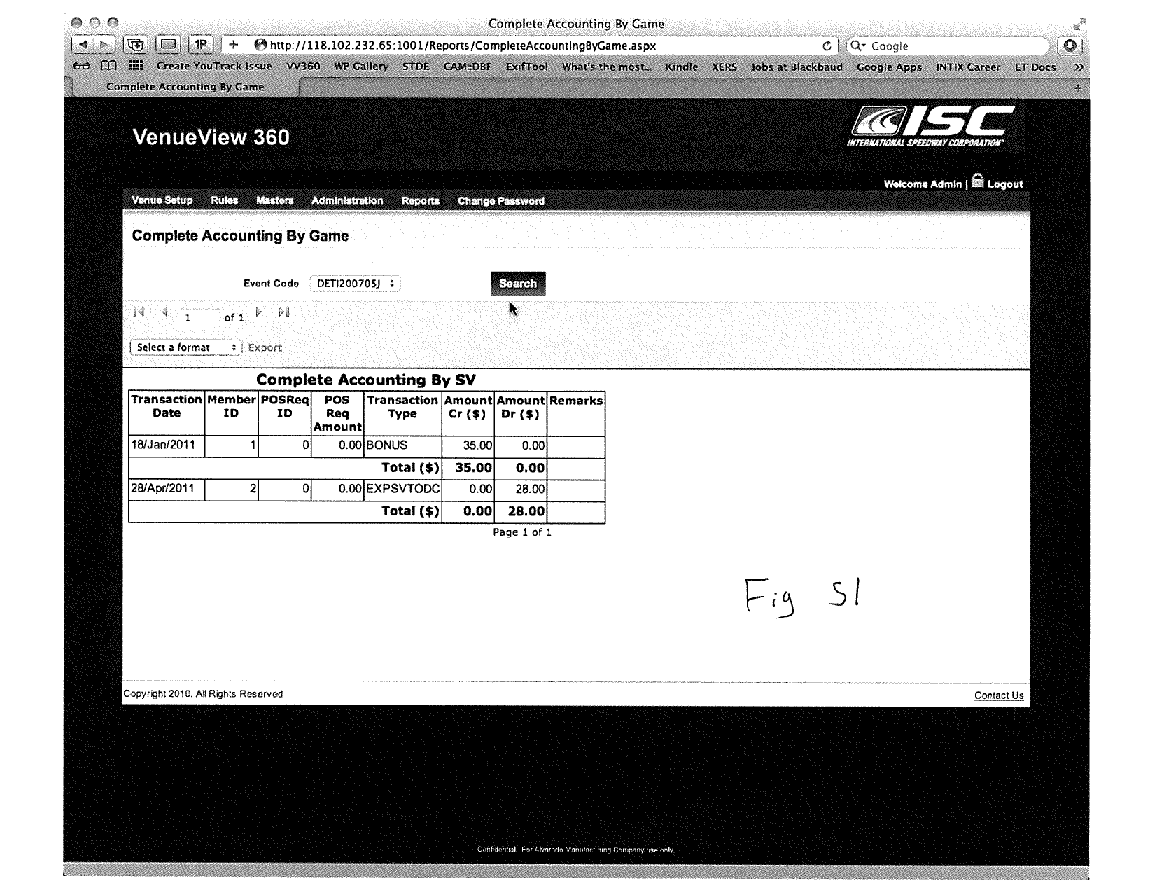

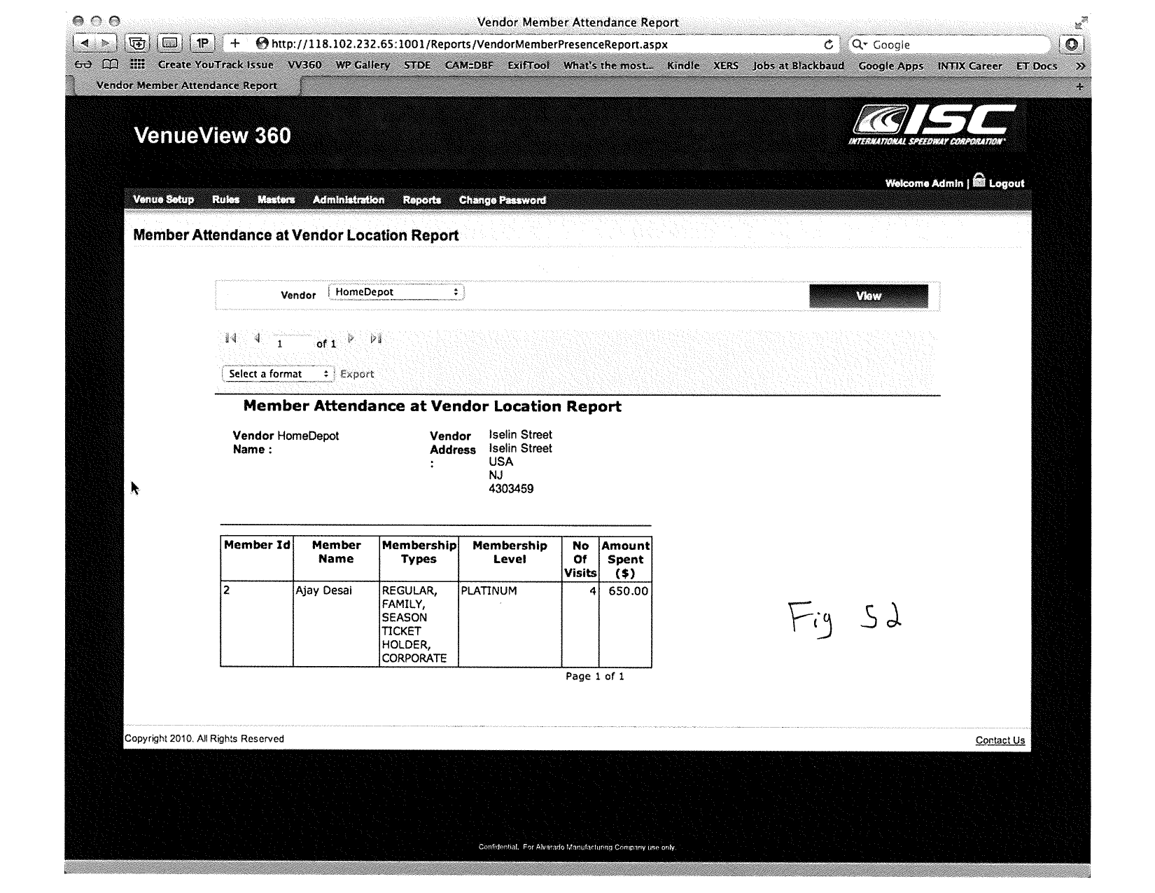

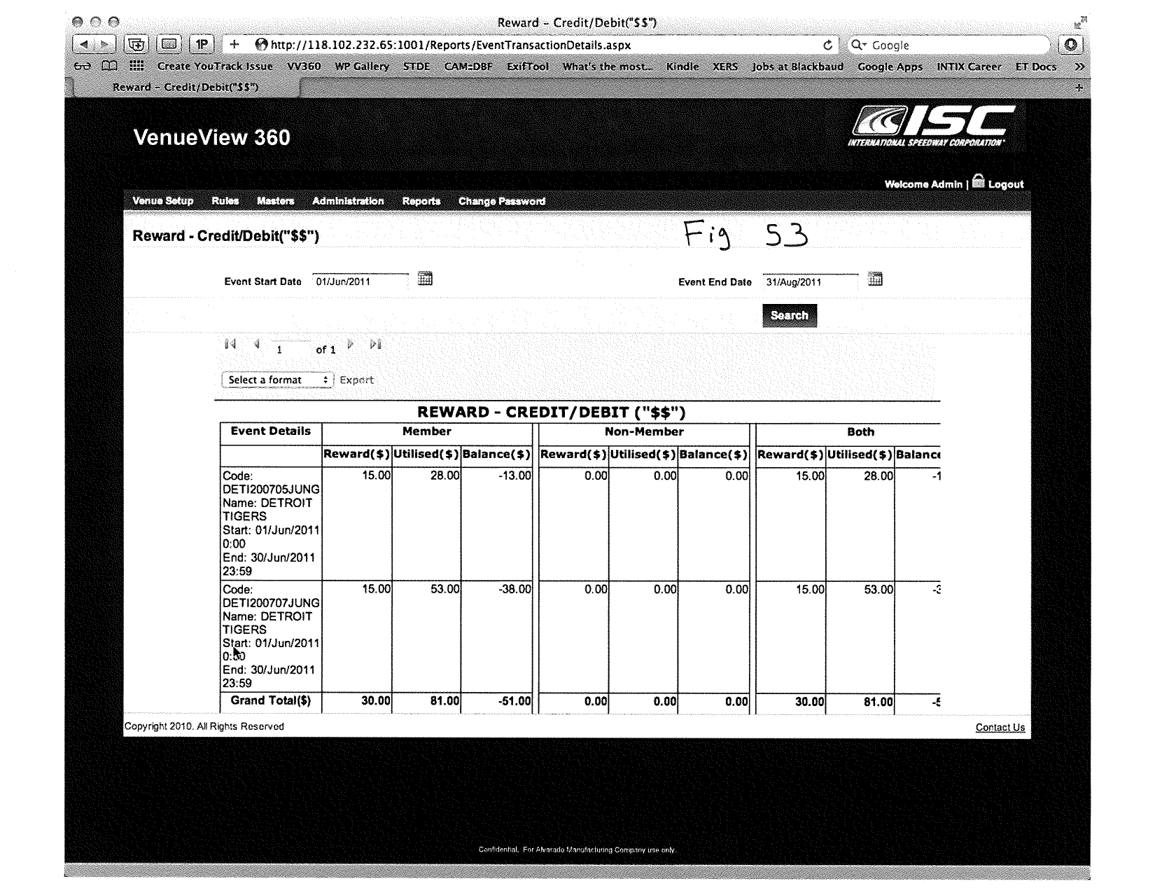

Sample screen displays of an exemplary administration portal are shown in FIGS. 21-53. As with the patron portal, an administrator or other person related to a venue or team may launch and log-in to the portal as shown in FIG. 21.

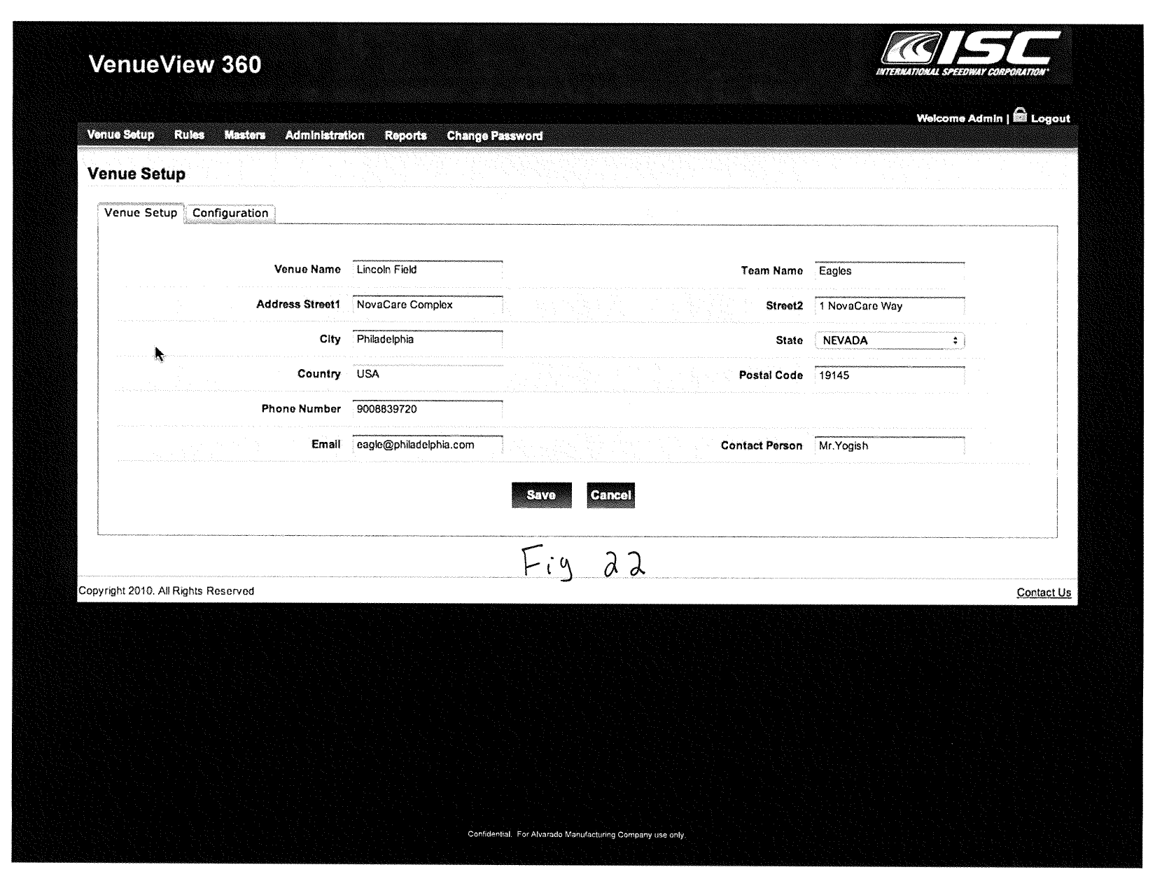

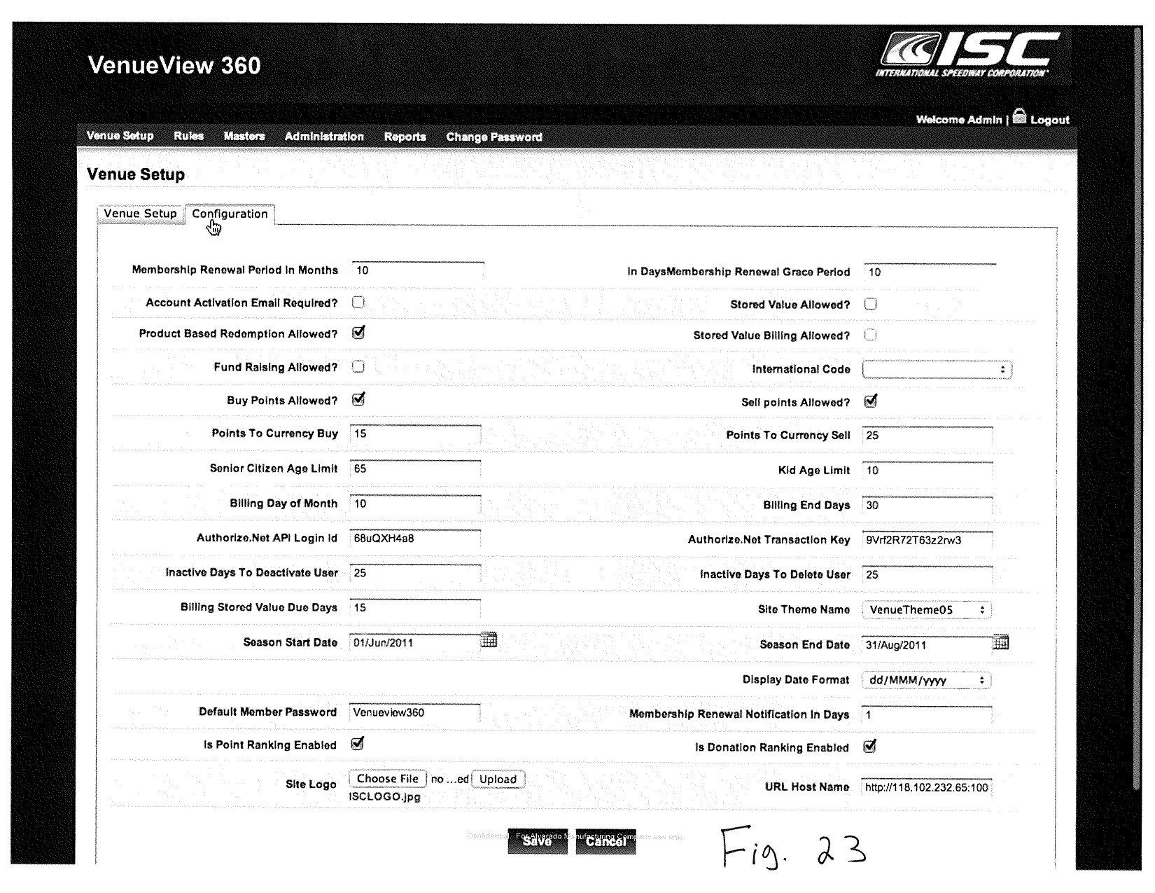

Once logged in, a main page shown in FIG. 22 is displayed. A Venue Setup tab allows the user to provide setup data for the venue as shown in FIG. 22. A Configuration tab links to a screen shown in FIG. 23. This screen allows the administrator to configure a membership program for the venue.

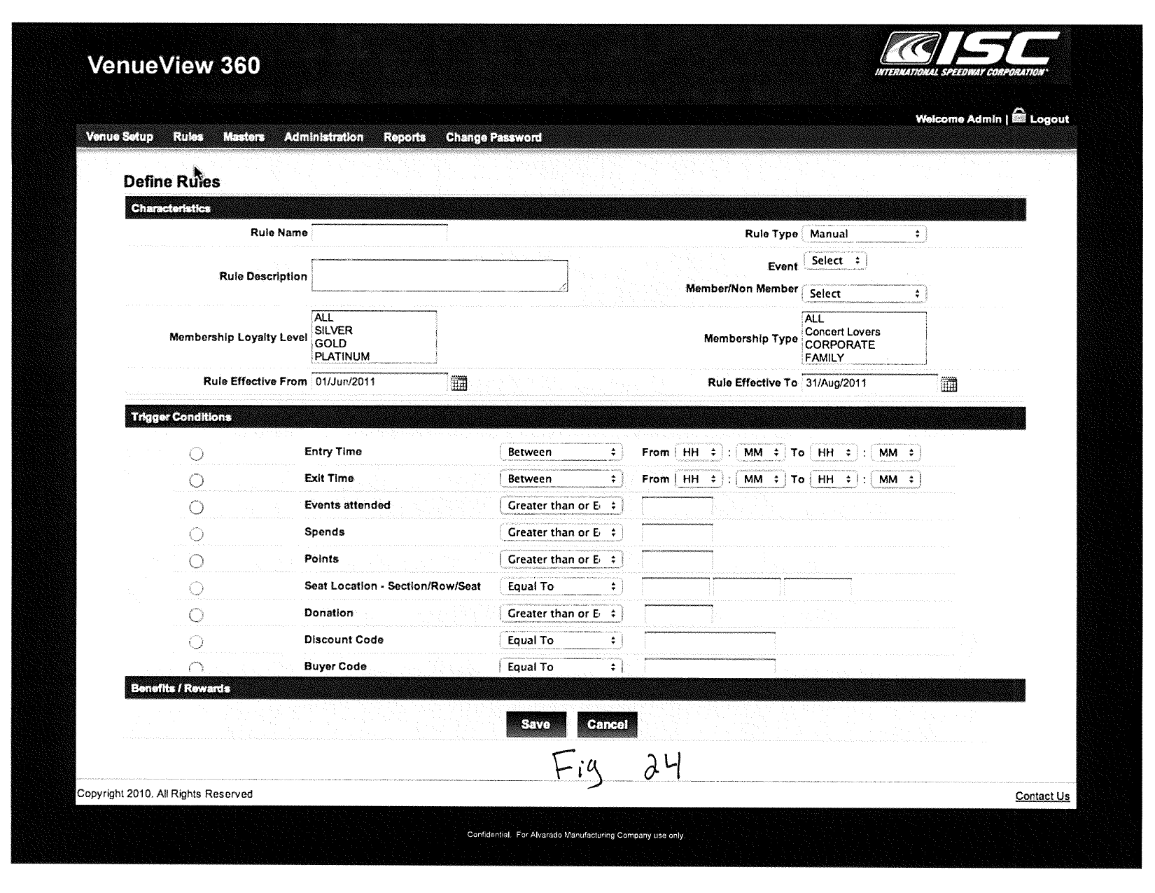

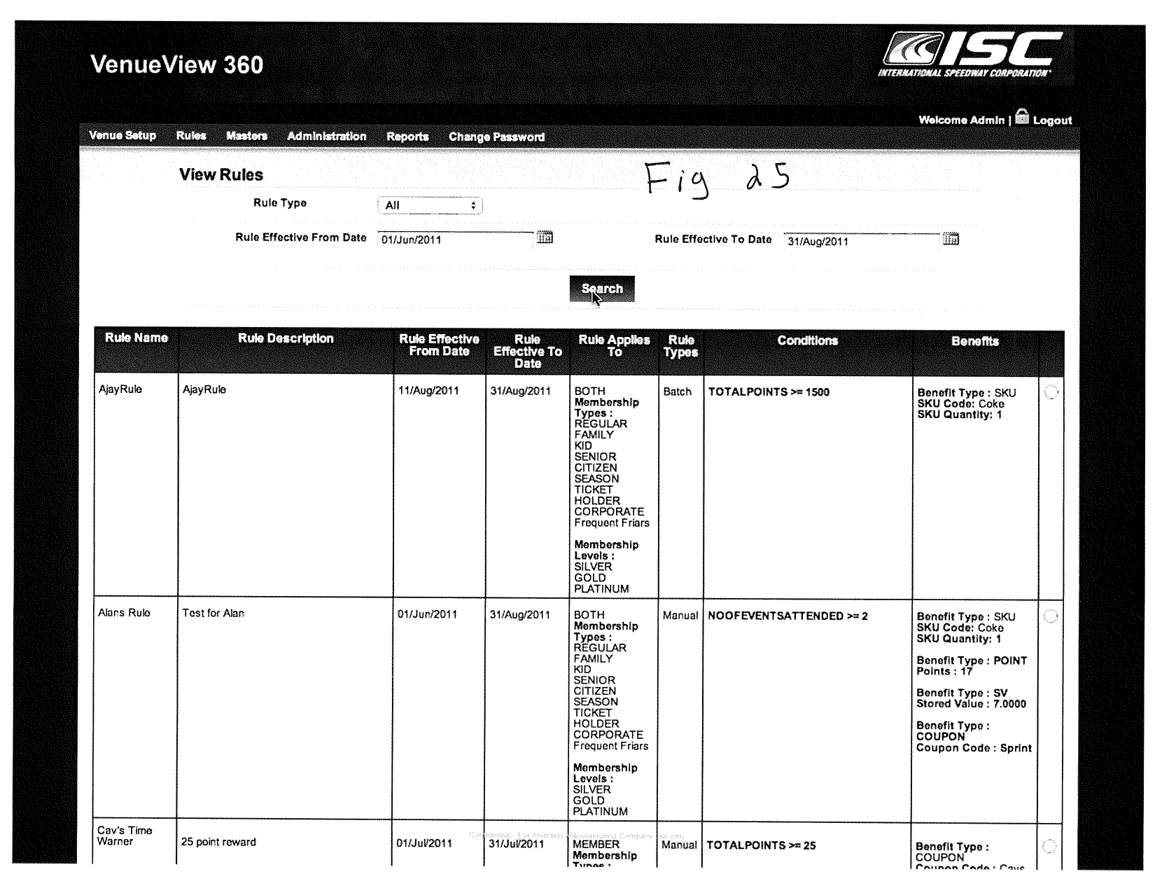

The main page also has a Rules tab that links to a screen shown in FIG. 24. This screen allows an administrator to create a rule for a reward by entering or selecting, among other things, a rule name, a rule description, a rule effective date, a rule type, an event to which the rule applies, the membership types which qualify for the rule, one or more trigger conditions, and the specific benefit or reward. The administrative portal may also allow searching of existing rules as shown in FIG. 25.

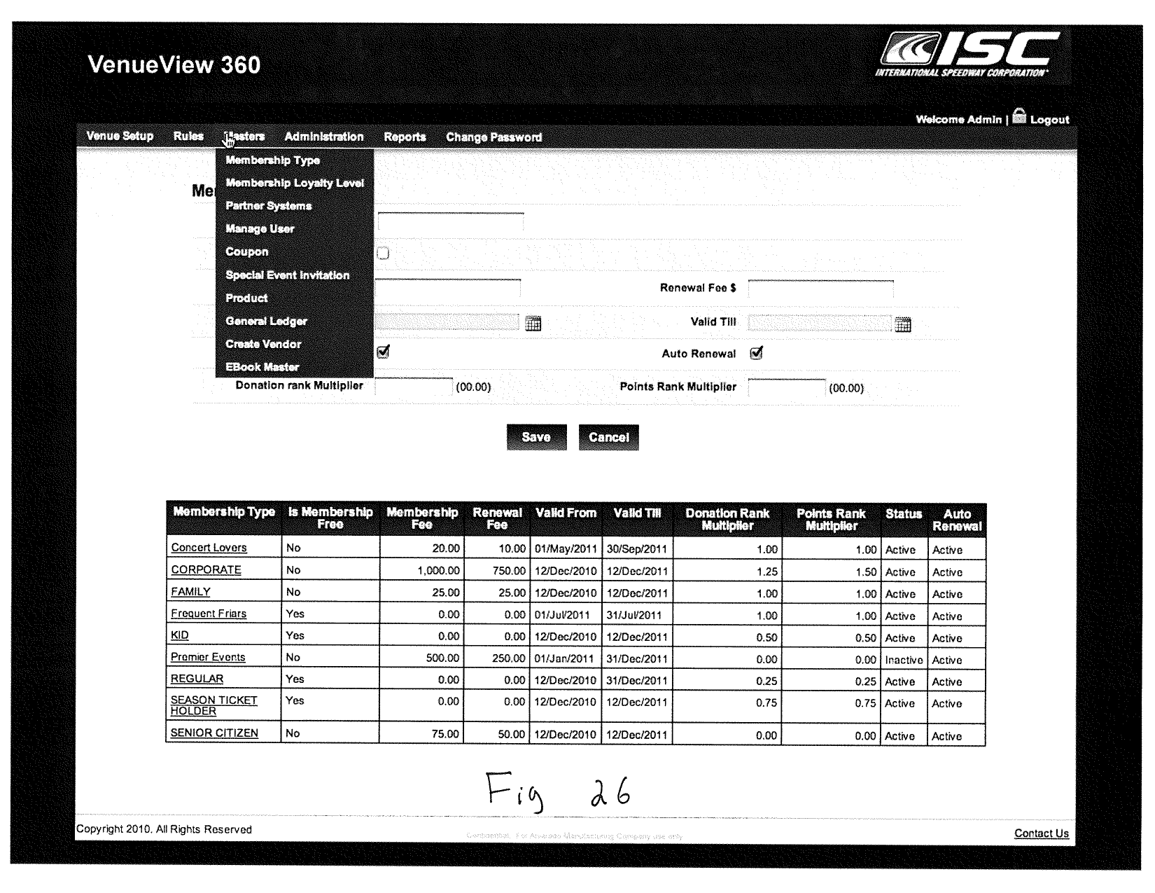

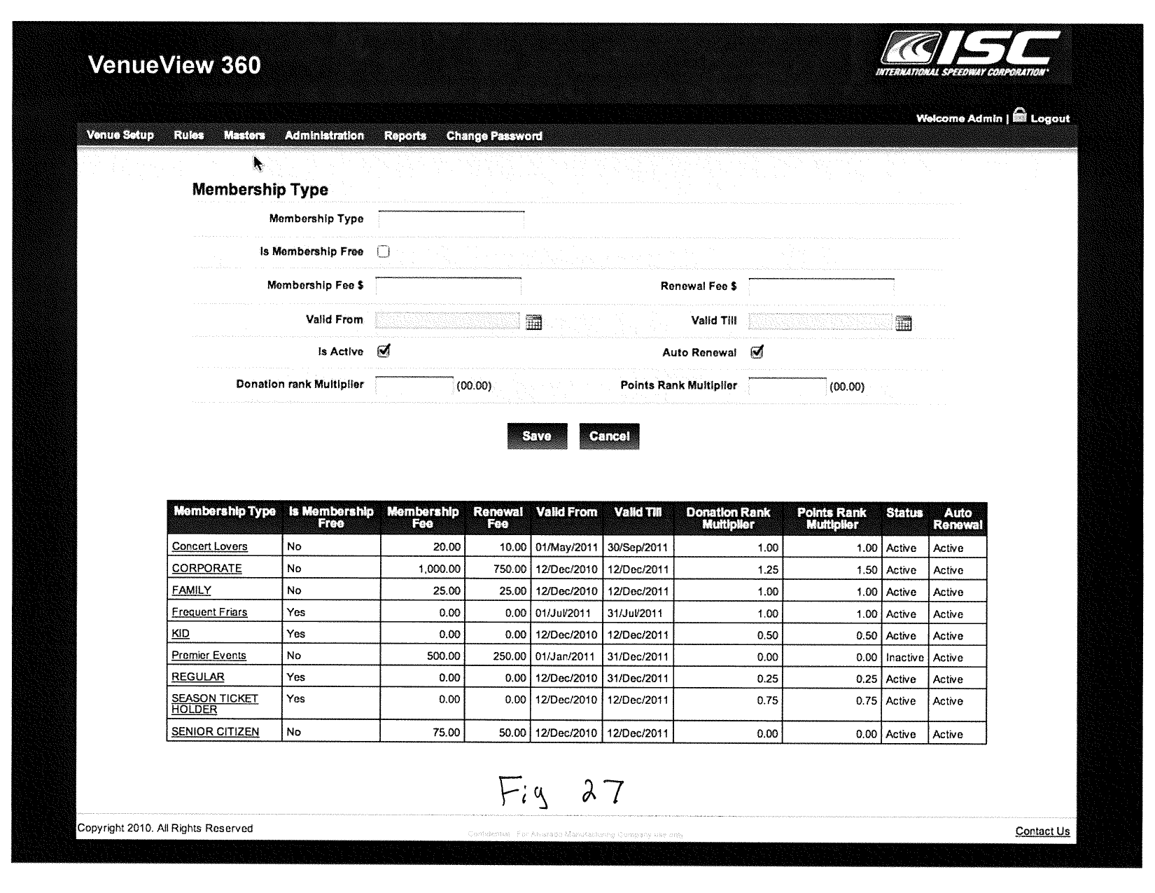

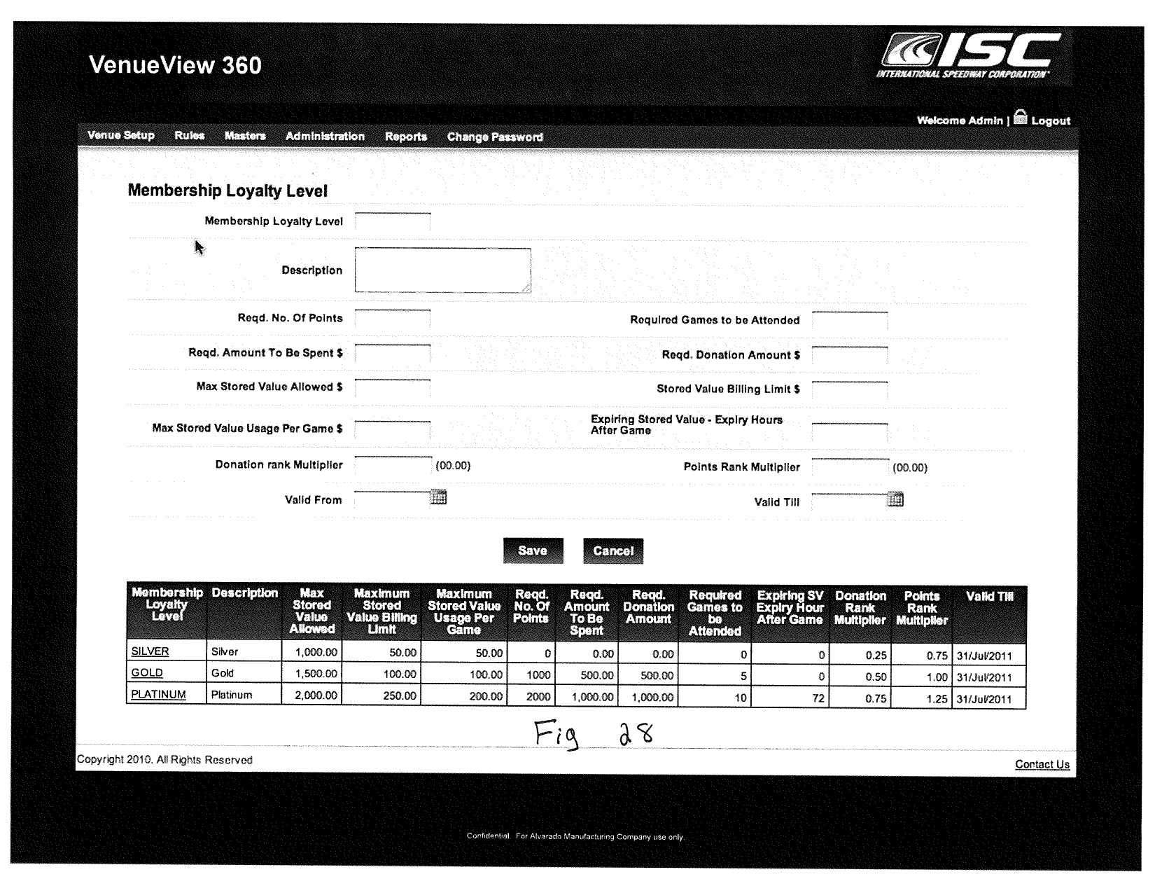

The main page also has a Masters tab that allows for the entry and/or selection of information related to membership types, levels, and other information as shown in FIG. 26. For example, this page links to a Membership Type screen shown in FIG. 27 that allows an administrator to configure multiple membership types. The screen of FIG. 26 also links to a Membership Loyalty Level screen shown in FIG. 28 that allows for the configuration of membership loyalty levels.

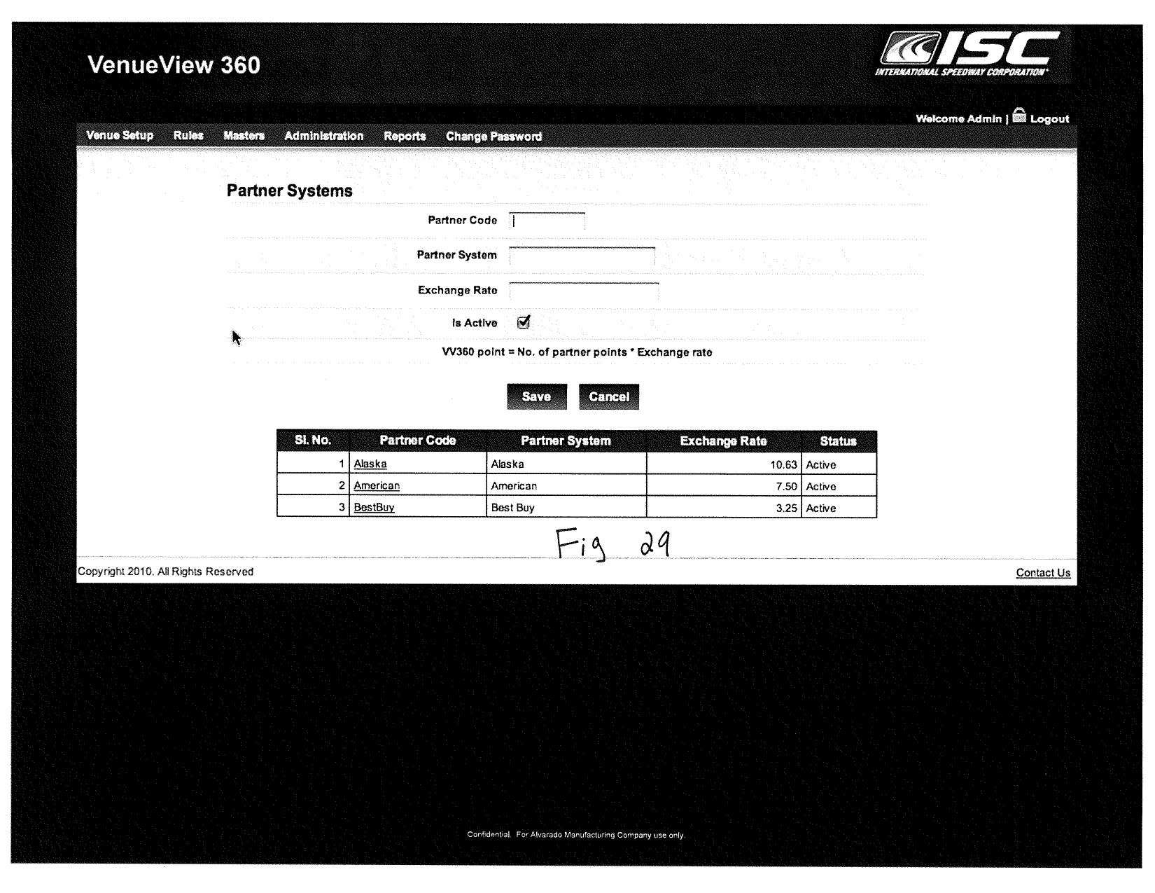

A screen shown in FIG. 29 allows an administrator to enter information from one or more marketing partners and to configure a point exchange between the venue management system and these partners.

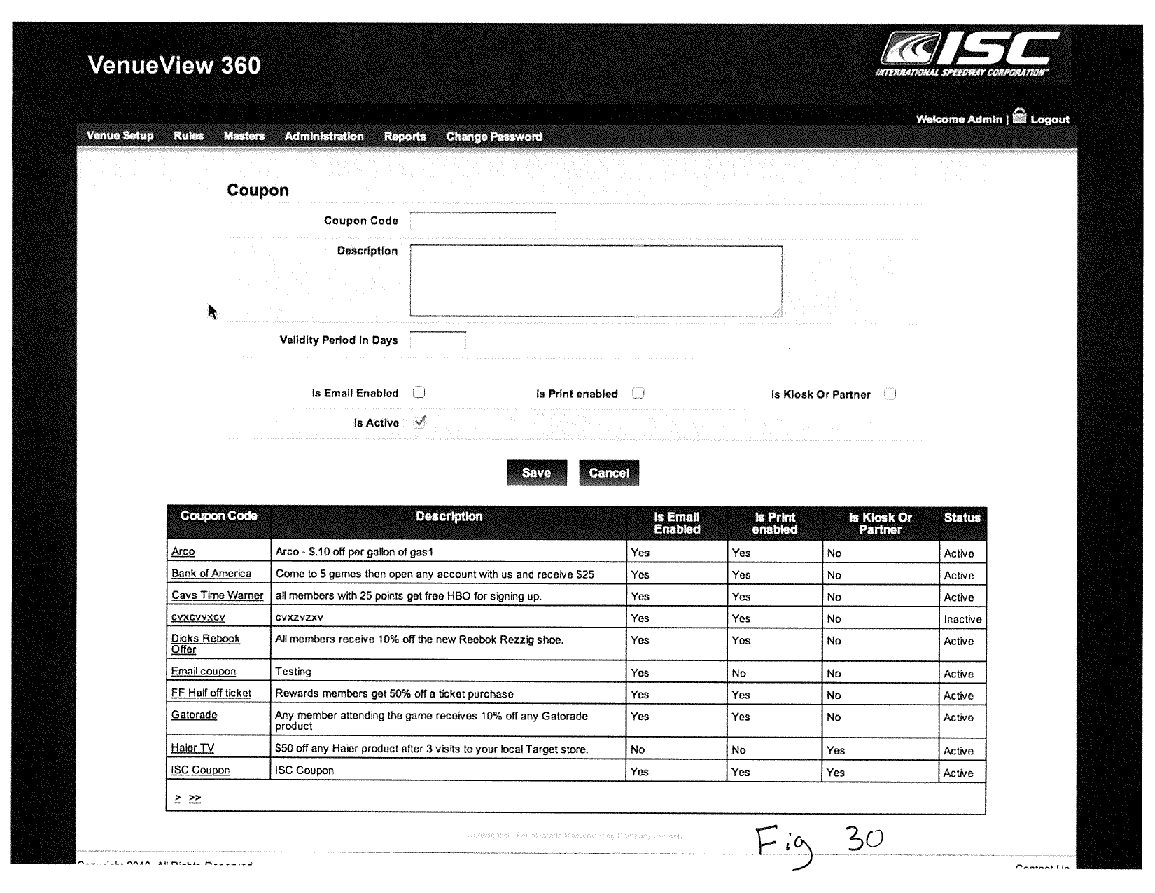

The screen of Fog. 26 also links to a Coupon screen shown in FIG. 30. This screen allows administrator to configure coupons from marketing partners.

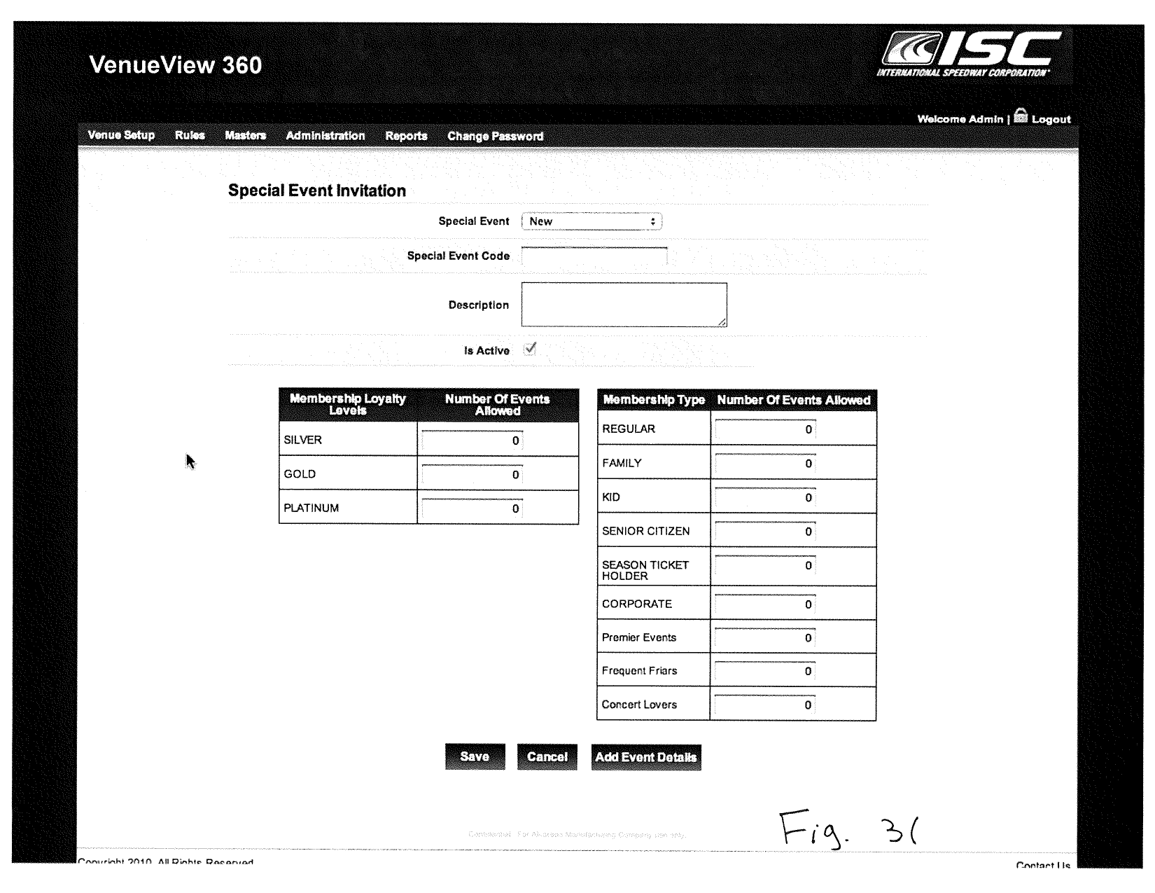

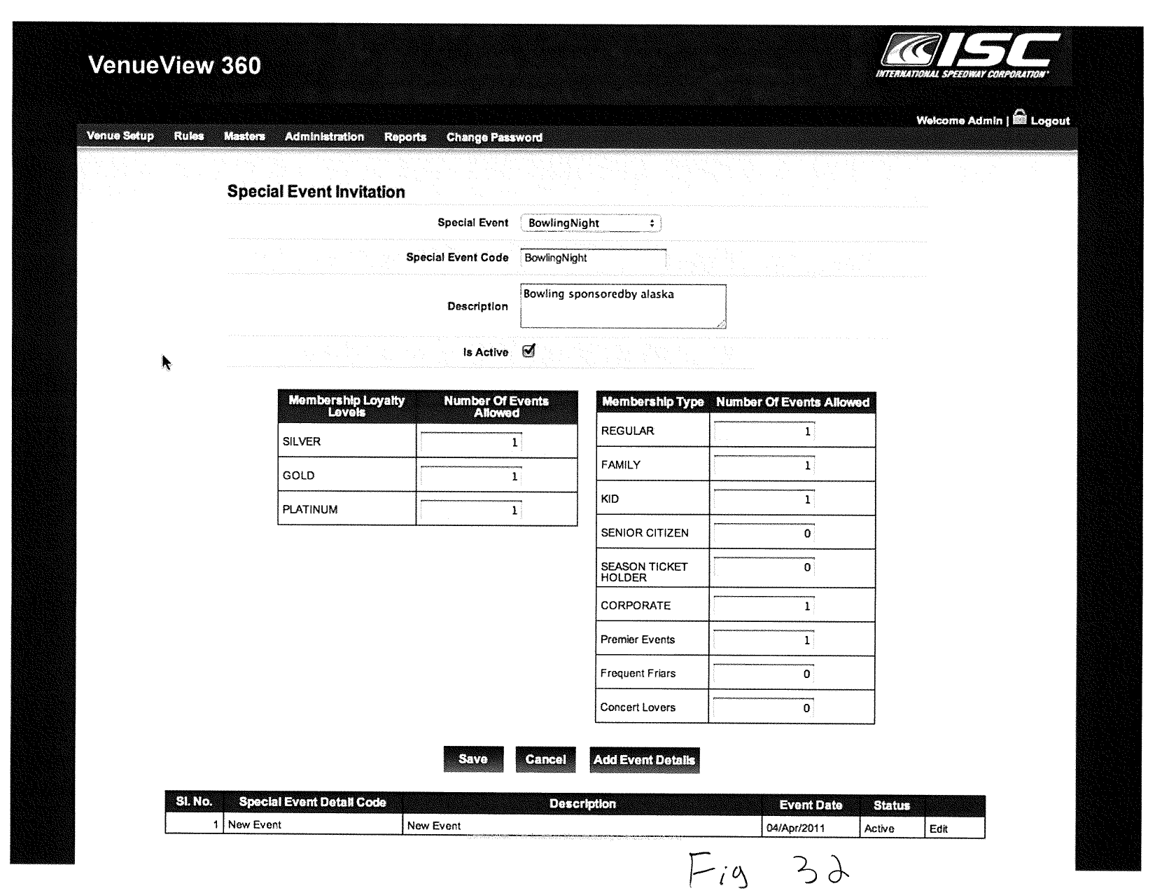

A screen shown in FIG. 31 allows for the entry of information from one or more special events. The screen permits an administrator to select the loyalty levels and membership types that qualify for the special event and the number of special events each is allocated. FIG. 32 shows exemplary information that has been entered for a particular special event.

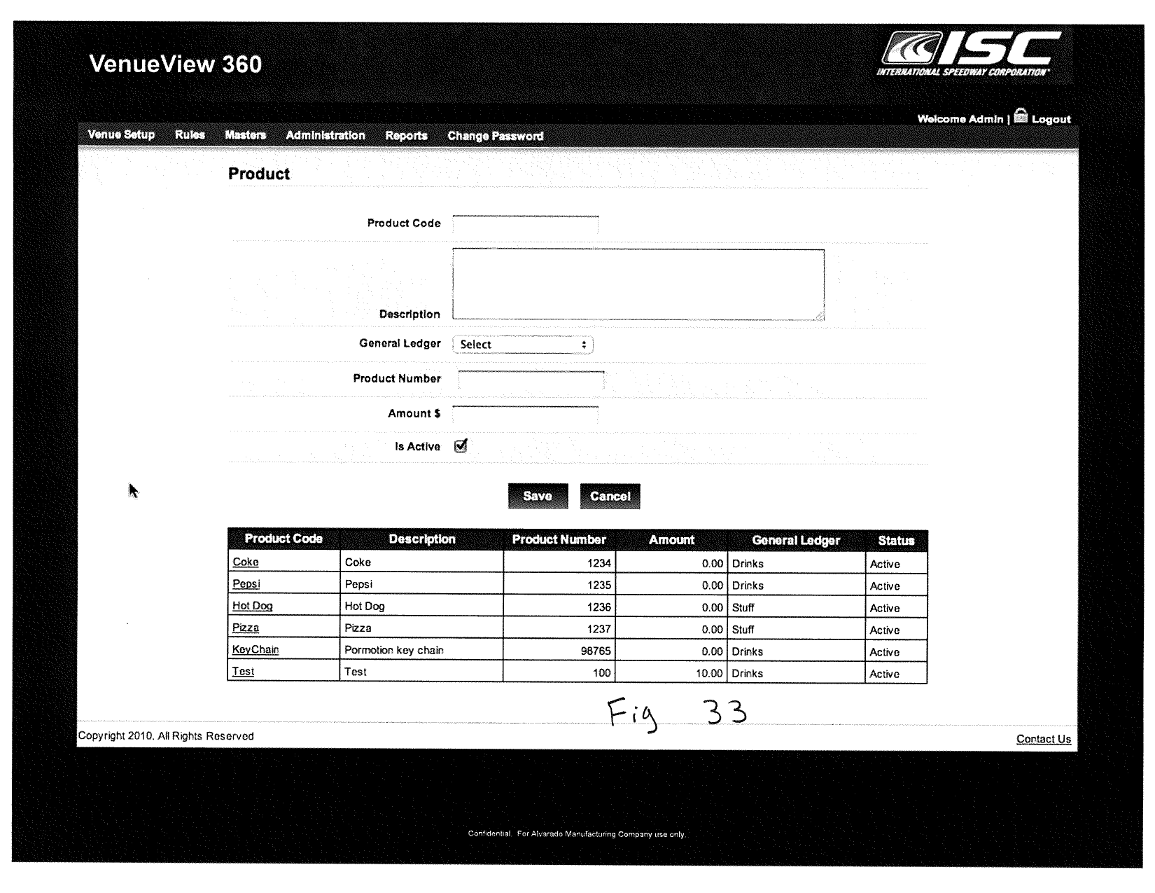

A screen shown in FIG. 33 allows for the entry of information for a product give-away.

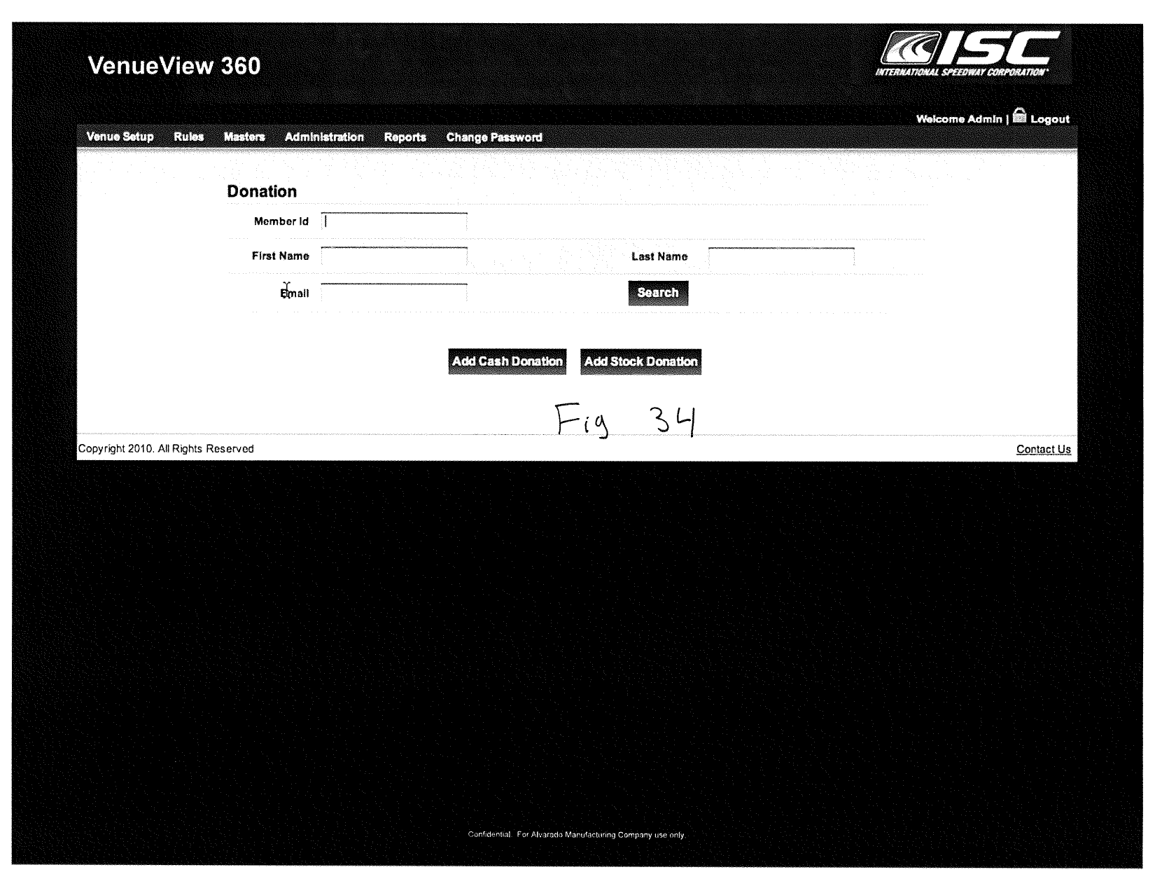

A screen shown in FIG. 34 allows an administrator to accept a donation from a member via the administrative portal.

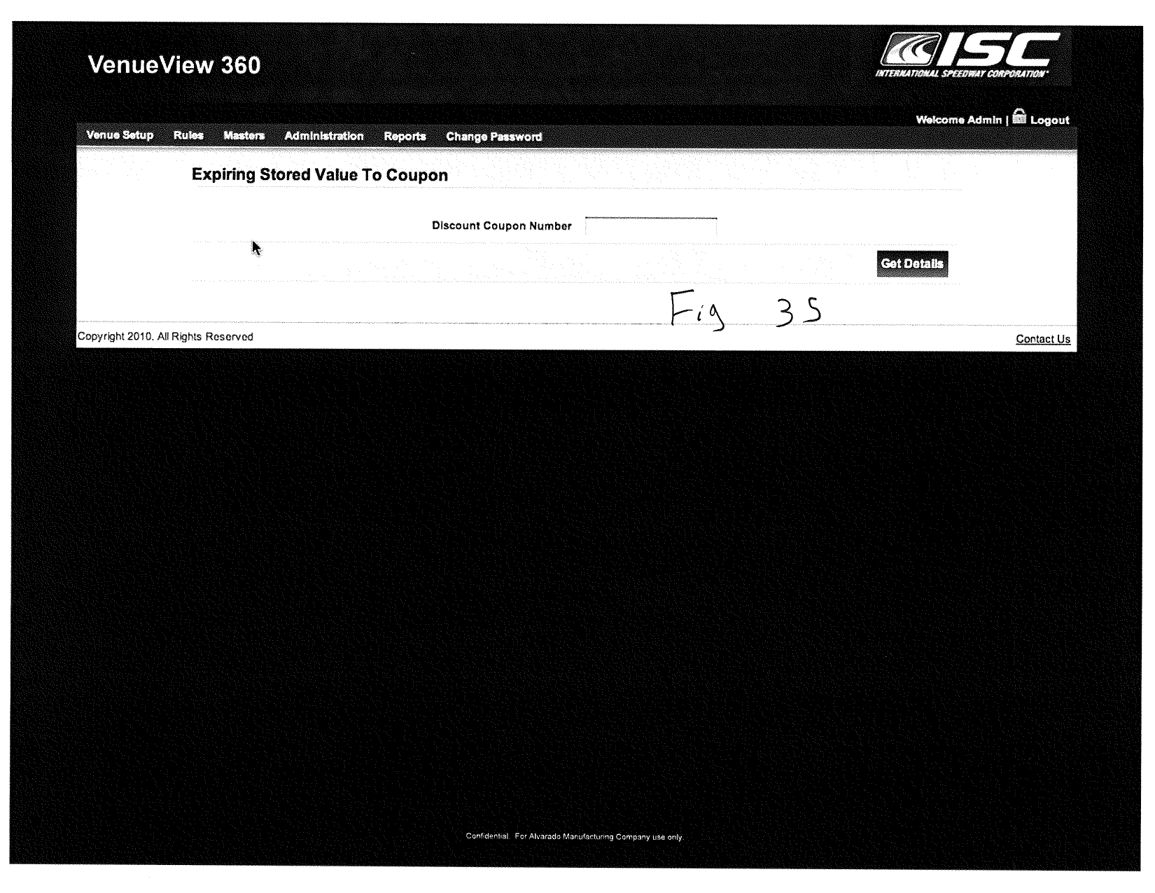

A screen shown in FIG. 35 allows for the transfer of expiring stored value associated with a patron account or ticket to a discount coupon.

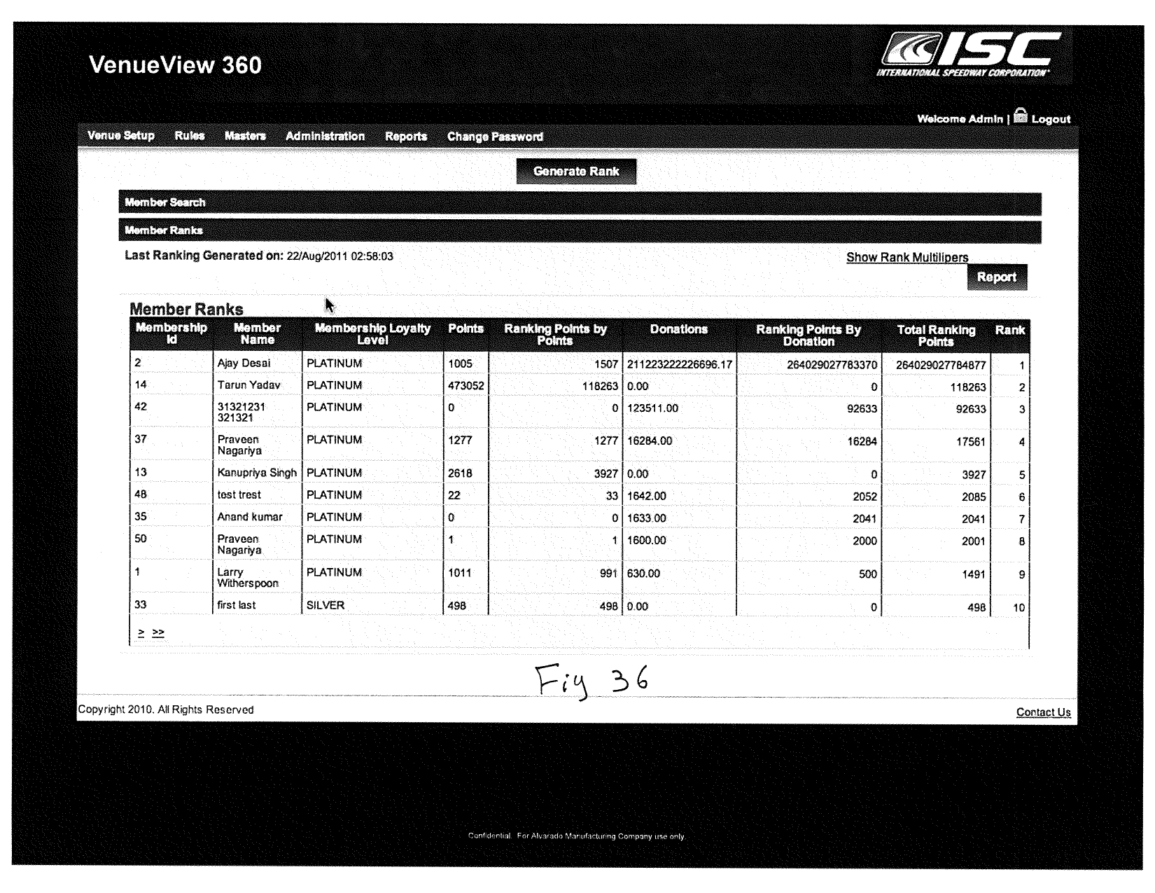

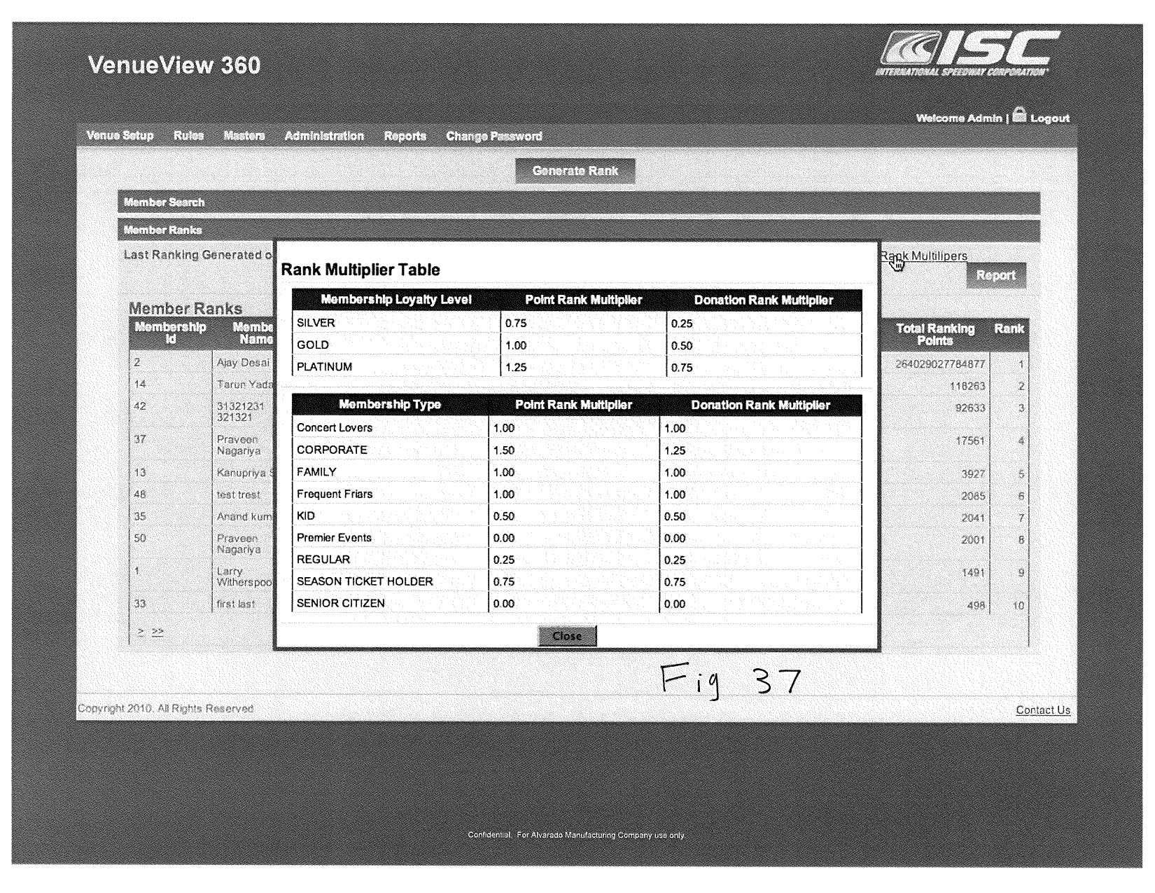

A screen shown in FIG. 36 ranks members based on several factors including their number of accumulated points, donations, etc. A screen shown in FIG. 37 allows an administrator to select and/or adjust rank multipliers.

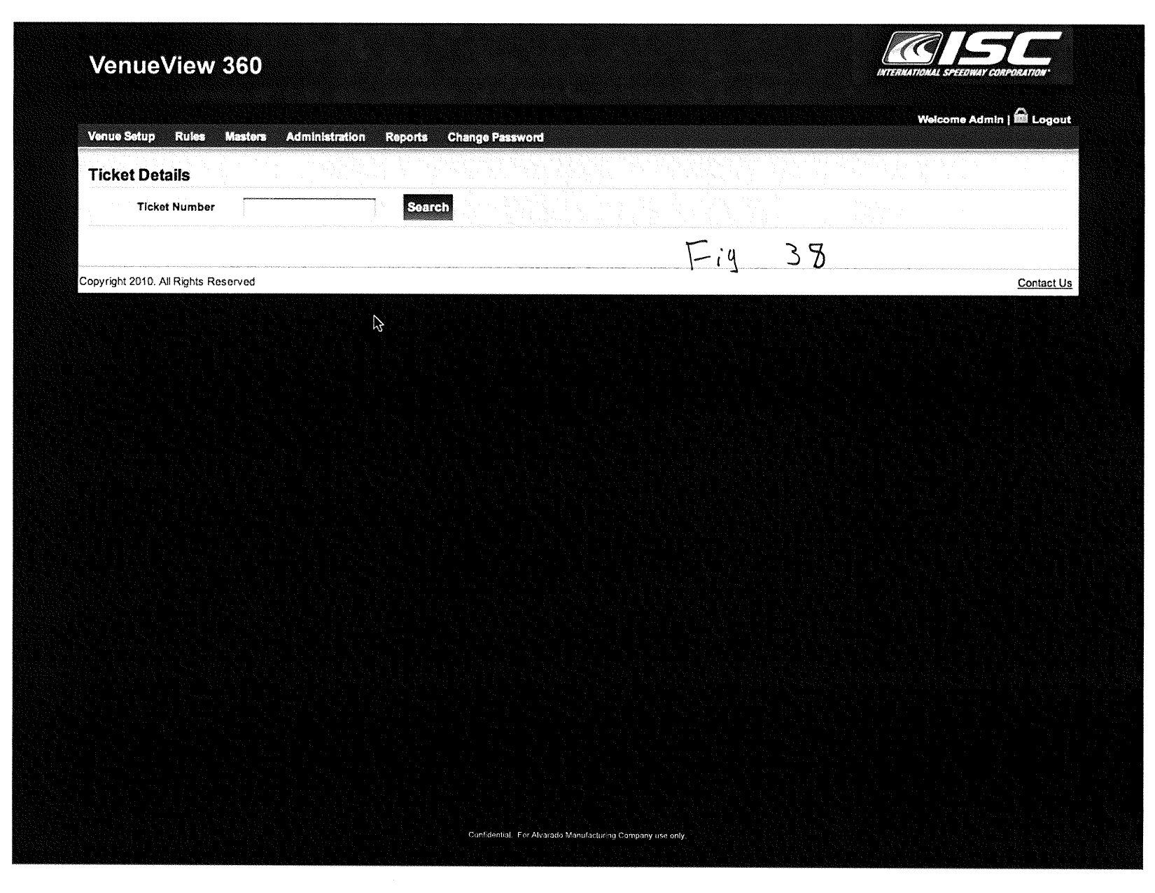

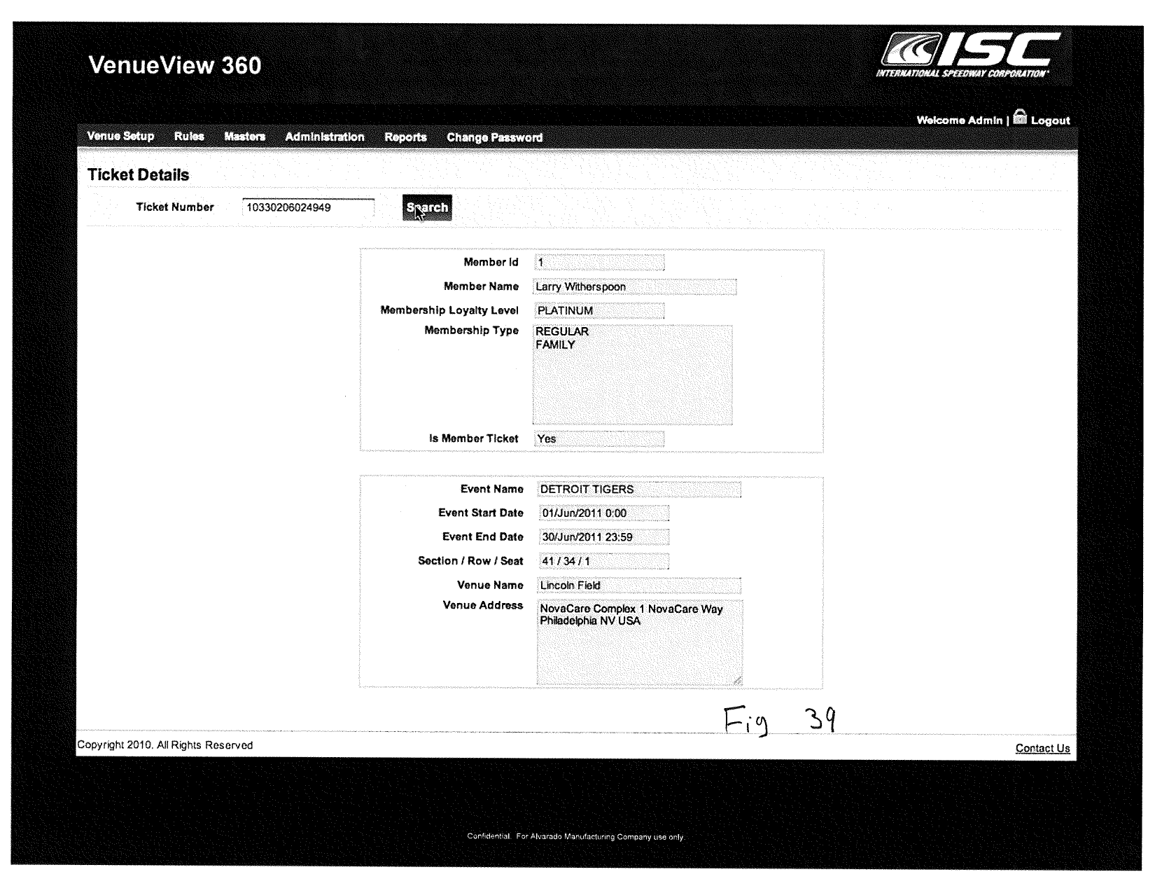

The screens of FIGS. 38 and 39 allow an administrator to search for a ticket and to obtain information about a ticket identified in the search.

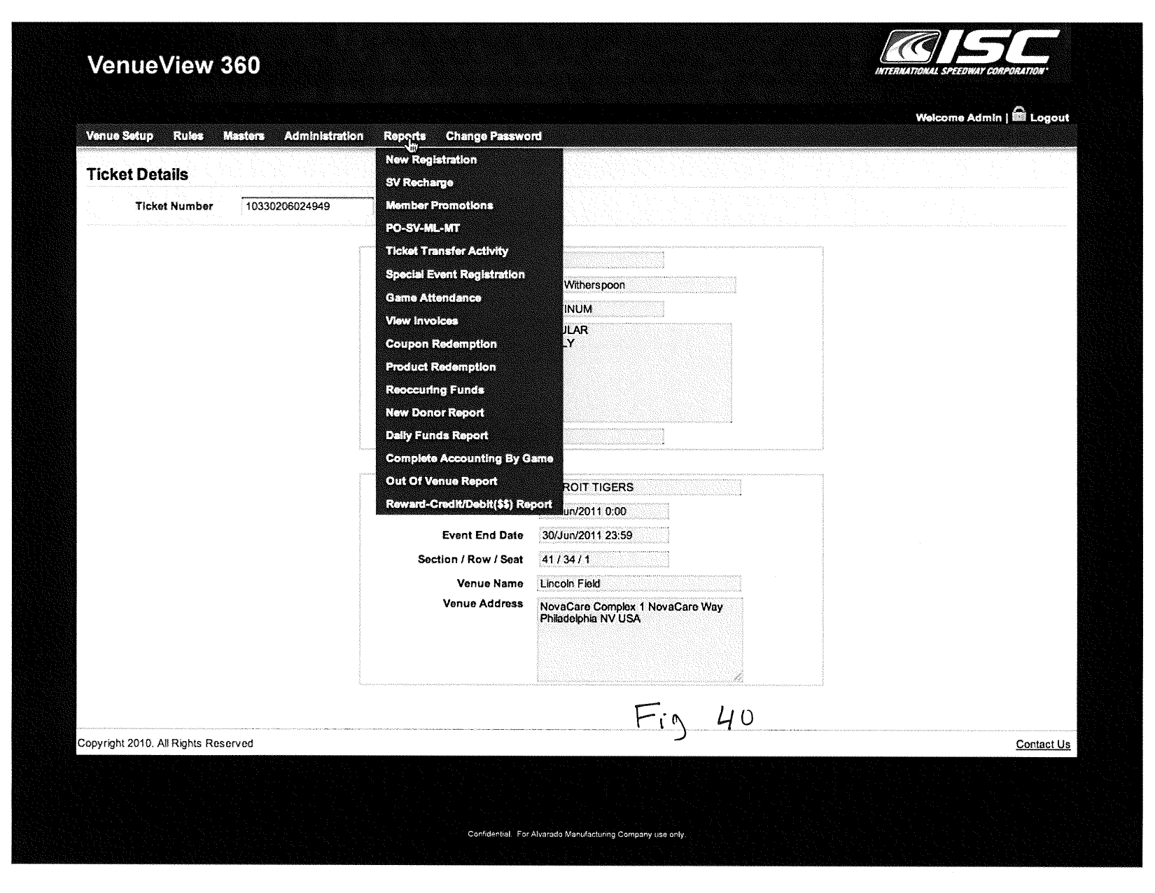

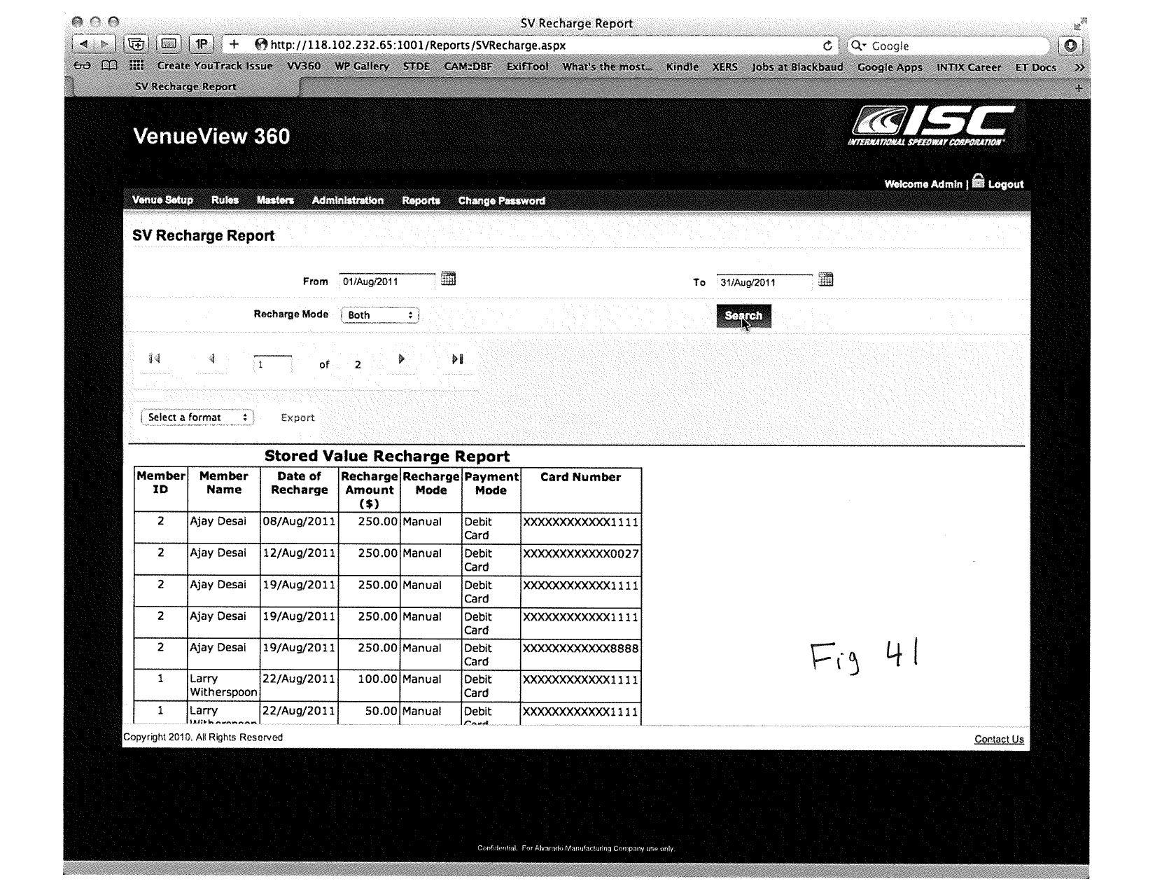

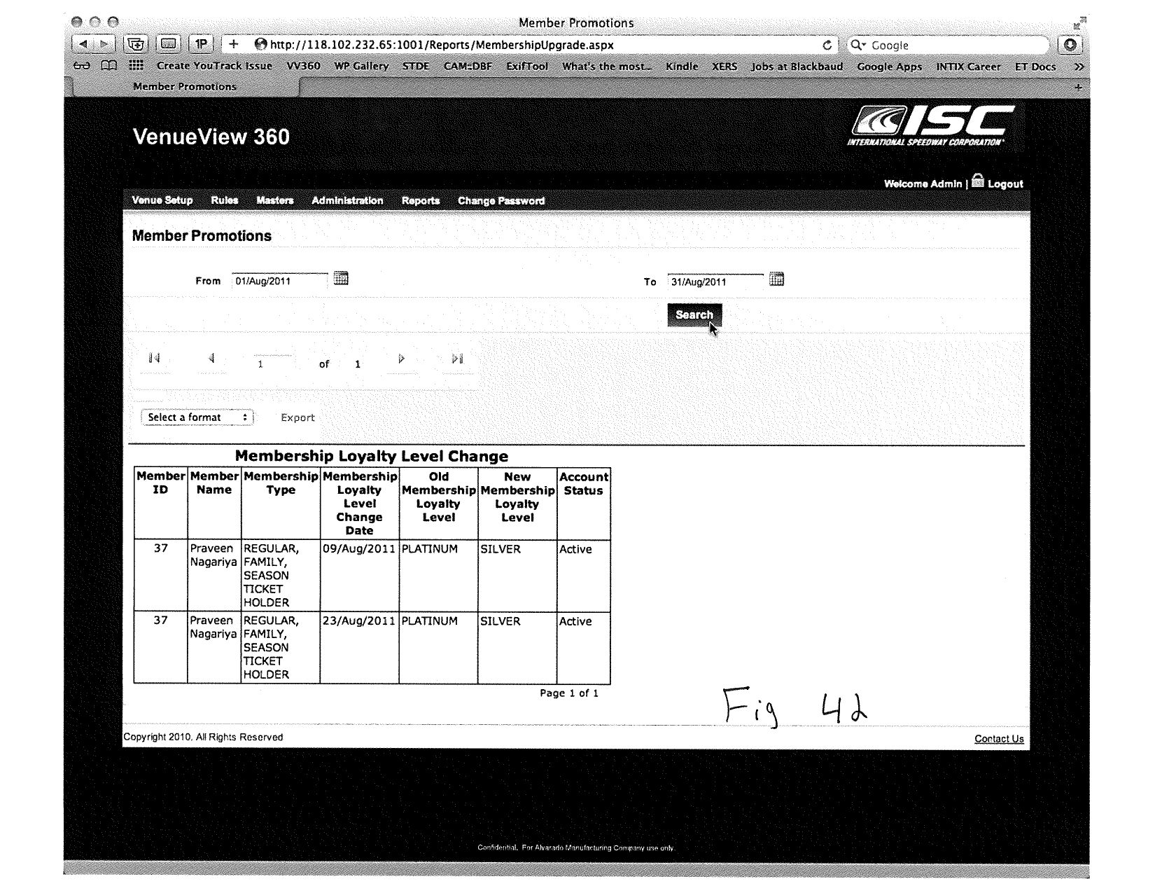

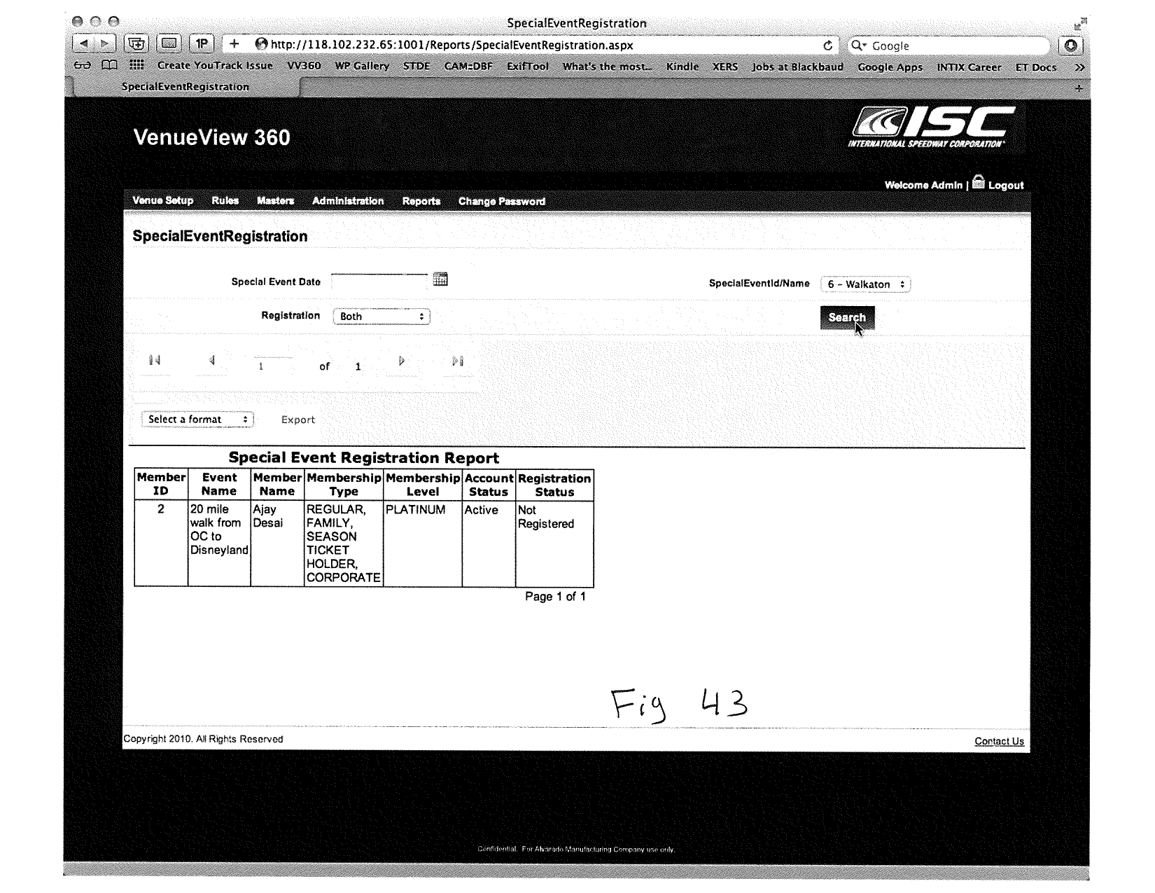

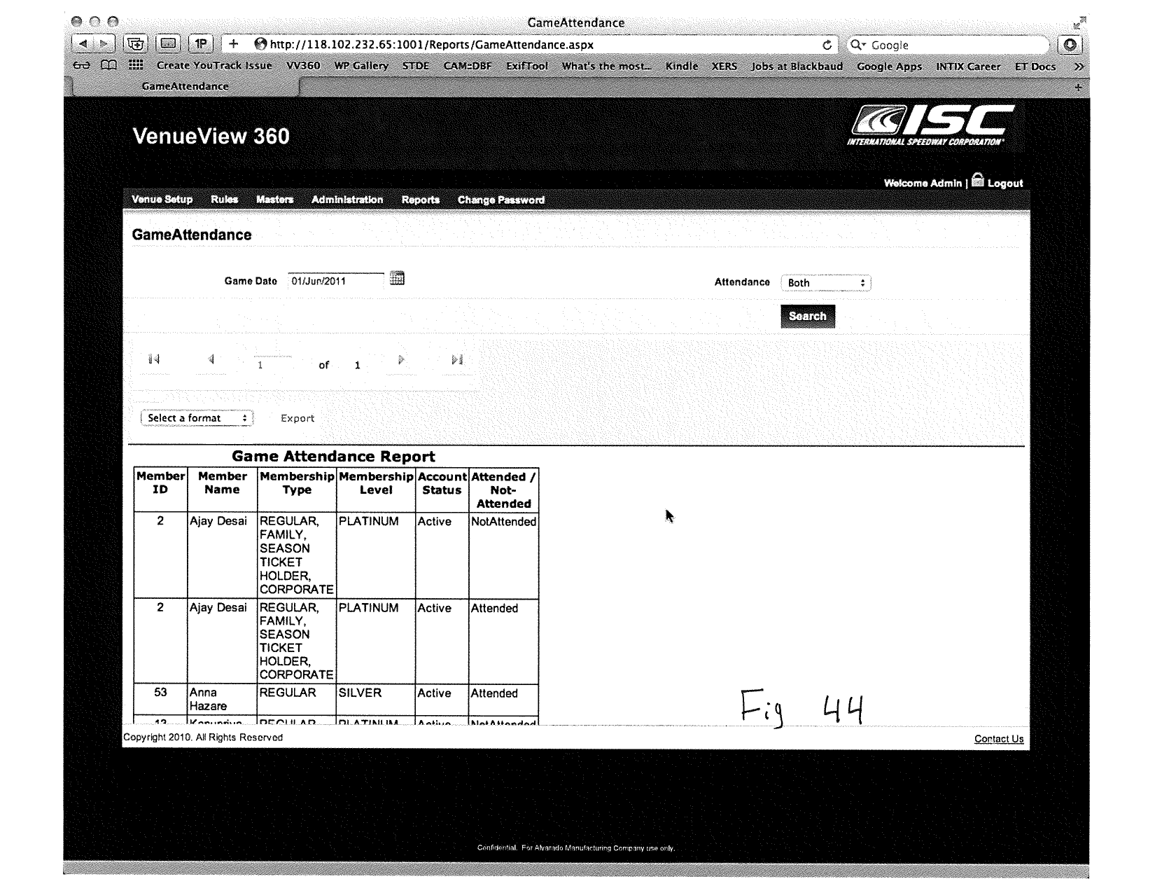

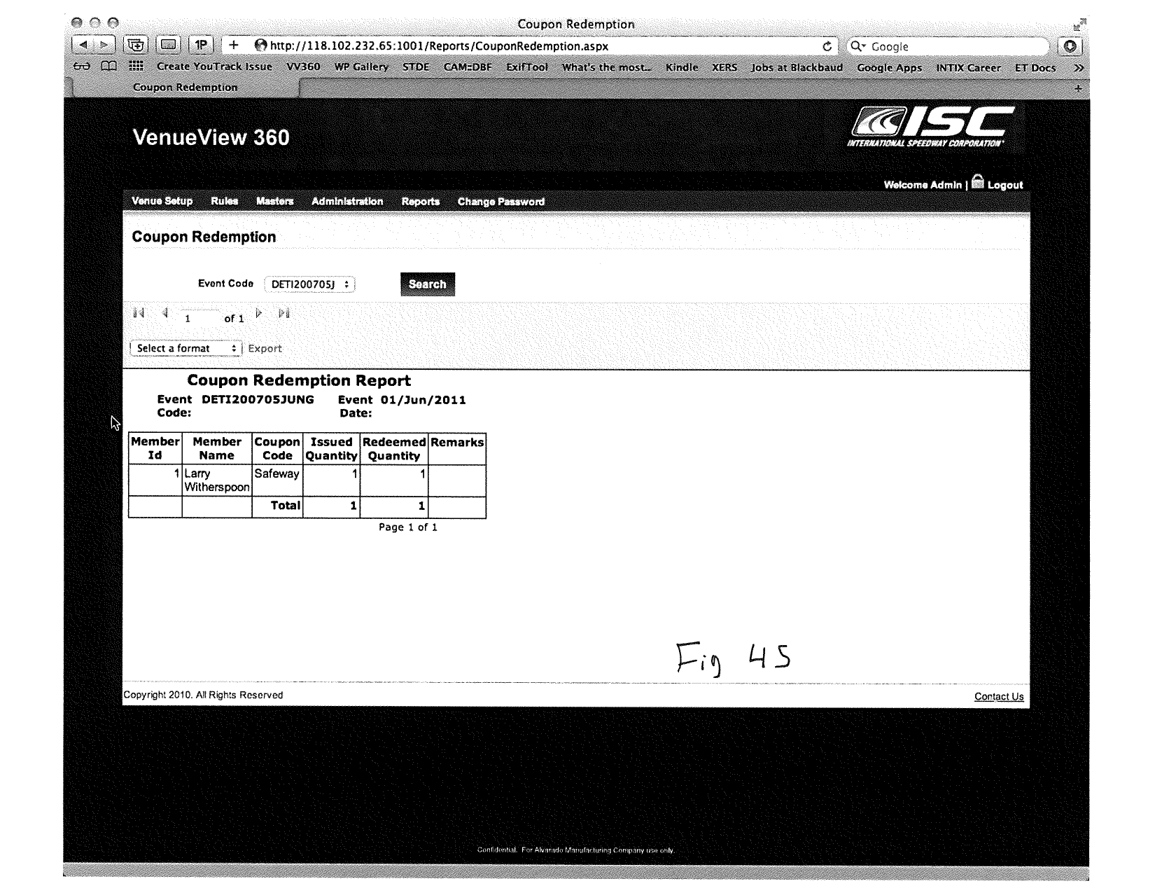

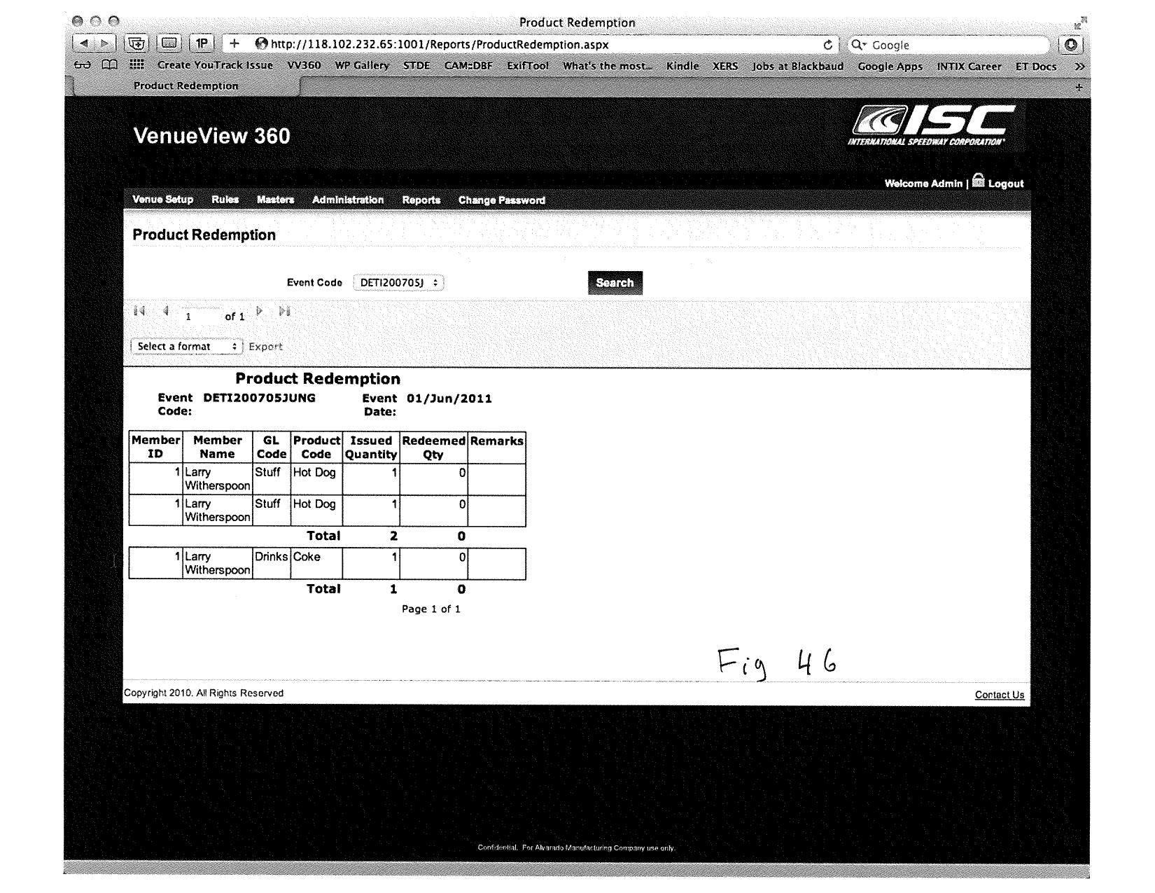

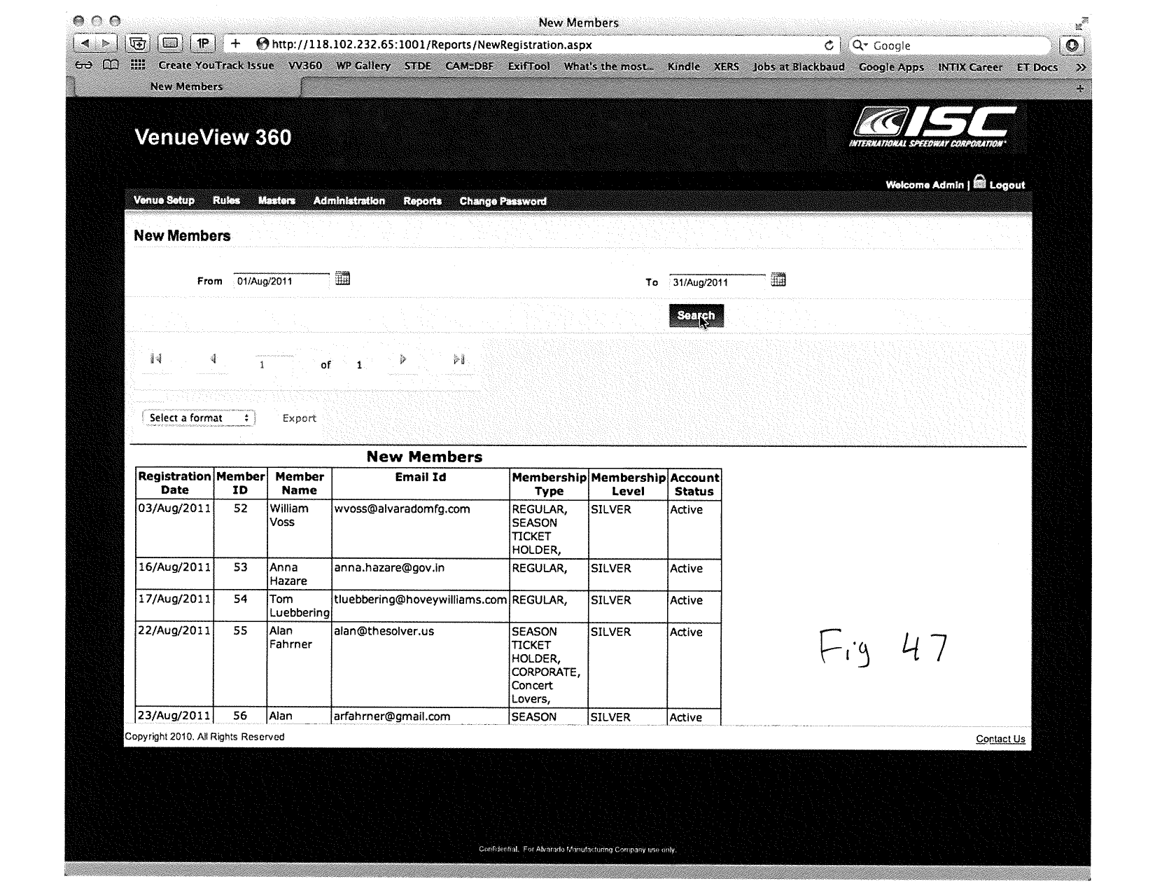

The screen of FIG. 40 allows for the printing and/or viewing of various different reports. For example, a Stored Value report may be viewed as shown in FIG. 41, a Member Promotions report may be viewed as shown in FIG. 42, a Special Events Registration report may be viewed as shown in FIG. 43, a Game Attendance report may be viewed as shown in FIG. 44, a Coupon Redemption report may be viewed as shown in FIG. 45, a Product Redemption report may be viewed as shown in FIG. 46, and other reports may be viewed as shown in FIGS. 47-53.

The venue management system may also implement a TV Widget application. The TV Widget is an add-on module developed across multiple modules allowing use on the Google, Yahoo, Roku and Samsung interactive television platforms. The Widget can be downloaded by a patron with the appropriate device and allows them to gain benefits solely by watching an event or sponsored event. Events may be streamed to a smart phone or other mobile device or broadcast by conventional TV networks and viewed on conventional TV's.

A patron can also login to the patron portal via the widget and check their account status. Once logged in, a patron can watch a required event, and the widget will automatically update their account with points/rewards based on their length of viewing. The widget information provided to the venue management system will trigger rules that the venue established in the rules engine.

The widget may also allow patrons to answer polled questions and then display the results on the widget. Patrons can be rewarded with stored value, points, or other incentives for participating in the polls.

The system may also display sponsored banners that can be selected to redirect the patron to the sponsor site or be given a coupon specific to the sponsor.

The loyalty and membership programs implemented by the venue management system 12 may be sponsored by marketing partners. For example, the programs of the present invention could be branded completely under a title sponsor's name. If the sponsor has existing loyalty programs, the membership and/or loyalty programs could be tiered to match the sponsor tiers as well as allow the program to be linked. The sponsor could also align campaigns and coupons around the levels for both programs.

The loyalty and membership programs may also have one or more coupon sponsors. This allows a sponsor to provide coupons to drive traffic to their stores based on sponsored incentives with the venue. The rules engine would give the venue the ability to automate the entire process.

The venue management system 12 may also allow a retailer to integrate directly to the system for the redemption of coupons. Based on this functionality, the rules engine has the ability to execute rules that are 1) only good at a retailer location and 2) can be based on the number of visits a fan makes to the retailer the amount spent at the retailer, and/or the specific products purchased at the retailer. Not only is the coupon distribution controlled, but it offers sponsors the ability to offset costs for promotions with their partners. For example, the rules engine may execute the following coupon rule:

| NUMBER OF VISITS | BEST BUY | HOME DEPOT |
|---|---|---|
| 1 | 10% off | 10% off |
| 2 | 15% electronics | 20% off Lawn and Garden |
| 3 | $100 off Sony TV's | $50 off Nikita Power Drills |

If a retailer is unable to integrate with the venue management system, some of the same functionality can be provided with the use of QR barcodes and mobile devices.

Patrons may also be able to link their venue membership/loyalty accounts to multiple partner loyalty programs. Partners could then have the ability to sponsor “points Nights” and issue points only good on their systems or incentivize patrons to transfer points to their system.

The venue management system 12 also allows for the gifting of money to a patron account or ticket based on the rules in the rules engine. For example, a stored value sponsor could fund a “$5 come in by 5pm on Tuesday night” program and provide every patron who arrives early a coupon for a like amount at their retail location.

The venue management system 12 may also include registration partners. A registration partner can generate messaging to a client based on their joining the venue program and linking the patron to their existing programs.

Product sponsors may give product(s) to patrons based on a rule trigger being met. Products can be redeemed in the venue upon the rules execution. Sponsors with new product or existing sponsors with a desire to increase their distribution would be able to provide that product free of charge to the patron. Additionally, the product could be part of an in-event promotion for additional exposure. Products may also be grouped and rewarded. For example, all season ticket holders may be awarded three sodas and three hot dogs per year. A product group tied to a SKU may also be created. The product group may have its own SKU redeemable at a POS but the SKU may be associated with multiple products. For example, SKU 12345 may be associated with one cookie, one hot dog, and one soda. Products may also be filtered if multiple products could apply. Products may automatically be credited during a transaction.

The addition, the TV Widget provides sponsorship opportunities for banner advertising, polling and game sponsorships. There are other sponsorships similar to the ones listed above for retailers but based on how many events are watched versus events attended.

The venue management system 12 also includes an analytics engine with multiple customizable reports to provide a venue the information they need to run an effective loyalty program and/or membership program.

Reports may include:
New Registrations—Provides a listing of the new registrations within a user defined timeframe.
SV Recharge—Provides a listing of the accounts and amounts for stored value recharges.
Member Promotions—A listing of patrons who were promoted from one loyalty level to another.
PO-SV-ML-MT—A report that list patrons in a ranked fashion by criteria entered by the user. Patrons can be ranked by points, stored value, loyalty levels and membership types.
Special Event Registration—A list of patrons who registered for an event.
Game Attendance—A list of members who attended an event.
View Invoices—Generates a report for invoices that were issued for stored value billing.
Coupon Redemption—A listing of the coupons that were redeemed within a defined date range.
Product Redemption—A listing of the products redeemed within a defined date range.
Re-occurring Funds—A report that lists the funds received from automated donation programs.
New Donor Report—A list of new donors within a defined date range.
Daily Funds Report—A listing of all donation activity for a defined date range.
Complete Accounting by Game—A complete listing of all stored value and coupon conversions for a defined event.

Embodiments of the system 10 may also be used to implement a check-in method for users attending events. Account information for at least one user may be stored in a user account administered by the venue management system 12 as described above. The account may be linked with or otherwise associated with at least one mobile device used by the user. The user may then use the mobile device to scan a Quick Response (QR) code or to enter other identification information associated with the event to show that the user has checked-in or otherwise arrived at the event. The venue management system may then associate a reward with the user account based on a user activity. The user activity may comprise: using the mobile device to scan the QR code at the event; using the mobile device to check-in to the event before a specified time or date; or using the mobile device to purchase a specified amount of goods or services while at the event.

In addition to a venue/team level membership, the system may also provide a high-level league or corporate membership. The system then allows for the programs to be integrated for points/benefits or to remain separate. Example would be: Larry has an MLB.COM membership and a regular membership with the Mariners. He could use his MLB.COM card at the venue or the Mariners card to acquire points if they had the program integrated. Any benefit would appear on Larry's account. If the memberships were not integrated then Larry would have access to a MLB.COM account to gain points for league, on-line or out-of-venue behaviors and the Mariners card for the venue, local retailer behaviors. Points could still be transferred between through the marketing partner module if desired. Example 2: Larry has an AEG membership that is good for benefit accumulation worldwide regardless of the AEG venue he visits. In the case of Staples center, he could be rewarded by going to a Lakers game with his Lakers membership but get rewarded by AEG for a concert. AEG may also reward Larry for not only attending 2 concerts but also 3 LA Galaxy games,

Embodiments of the system 10 may also allow members and non-members to transfer tickets through outside ticketing partners. The system 10 may also allow members to transfer loyalty rights for a specific ticket or event between members and non-members. The system 10 may even allow for members to transfer coupons, products, invitations, and other benefits between member accounts.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A non-transitory computer-readable storage medium with an executable computer program stored thereon, the computer program comprising:
a code segment for receiving identification infoimation for a ticket to an event at a single stationary venue, and
a code segment or segments for implementing a rules engine that associates a reward or incentive with the ticket upon occurrence of a trigger;
a code segment or segments for designating a trigger and a reward for a portion of the event and a different trigger and different reward for a different portion of the event; and
a code segment for changing the reward or the user activity during the event according to input received by an administrator.

2. The computer-readable storage medium as set forth in claim 1, wherein the trigger occurs: when a patron uses the ticket to enter the venue at be re a specified time or date prior to an event; when the patron uses the ticket to purchase a specified amount of goods or services in the venue or out of the venue; when a team or group performing in the venue completes a specified action; when the patron donates a specified amount of money to a cause affiliated with or endorsed by the venue; when the patron attends a specified number of events; or when the patron accumulates a specified number of loyalty points associated with the ticket.

3. The computer-readable storage medium as set forth in claim 1, wherein the reward or incentive includes a stored value, loyalty points, a coupon, an invitation to a special event, or a free or discounted product or service.

4. The computer-readable storage medium as set forth in claim 1, wherein the ticket is a paper ticket, a paperless ticket, or any other media or device that permits the patron to enter the venue.

5. The computer-readable storage medium as set forth in claim 1, wherein the code segment or segments for implementing the rules engine permits the administrator to change the trigger, add new triggers, change the reward or incentive, or add new rewards or incentives.

6. The computer-readable storage medium of claim 1, wherein the code segment or segments for implementing the rules engine are operable for:
creating a plurality of membership levels for patrons of the venue;
receiving account information from patrons of the venue and creating an account for each of the patrons;
assigning each of the patrons to one of the membership levels; and
promoting patrons to different membership levels based on patron actions.

7. The computer-readable storage medium of claim 6, wherein the membership levels include a Family membership, a Season Ticket Holder membership, and a VIP membership.

8. The computer-readable storage medium of claim 7, wherein the code segment or segments for implementing the rules engine permits the administrator to assign different triggers and different rewards or incentives to each membership level.

9. (canceled)

10. A venue management system comprising:
a patron portal implemented by a computer system having memory, data processing, and communication elements and accessible by patrons of a venue, the patron portal configured to receive and store patron accounts from patrons and to store ticket information for tickets to the venue in the accounts; and
an administration portal implemented by the computer system and accessible by administrators of the venue, the administration portal having a rules engine configured to receive, store, and execute a rule from an administrator, wherein the rule is configured to award rewards or incentives to the patrons and associate the rewards or incentives with the patron accounts in the memory.

11. The venue management system as set forth in claim 10, the patron portal being further configured to permit patrons to associate stored value with their tickets in the patron accounts.

12. The venue management system as set forth in claim 10, the administration portal being further configured to receive and store a plurality of membership levels for the patrons from the administrator and to award, via the rules engine, different rewards or incentives for each of the membership levels.

13. The venue management system as set forth in claim 10, the administration portal being further configured to receive from the administrator and store, via the rules engine, different incentive triggers for each of the membership levels.

14. The venue management system as set forth in claim 13, wherein the trigger occurs: when a patron uses the ticket to enter the venue at a specified time or date prior to an event; when the patron uses a ticket to purchase a specified amount of goods or services in the venue or out of the venue; when a team or group performing in the venue completes a specified action; when the patron donates a specified amount of money to a cause affiliated with or endorsed by the venue; when the patron attends a specified number of events; or when the patron accumulates a specified number of loyalty points.

15. The venue management system as set forth in claim 13, wherein the reward or inventive includes a stored value, loyalty points, a coupon, an invitation to a special event or a free or discounted product or service.

16. The venue management system as set forth in claim 10, wherein the tickets are paper tickets, paperless tickets, or any other media or device that permits the patrons to enter the venue.

17. The venue management system as set forth in claim 13, wherein the rules engine is configured to receive a change to the trigger, add new triggers, change the reward or incentive, or add new rewards or incentives input by the administrator.

18. The venue management system as set forth in claim 10, wherein the rules engine is configured for:
creating a plurality of membership levels for patrons of the venue;
receiving account information from patrons of the venue and creating an account for each of the patrons;
assigning each of the patrons to one of the membership levels; and
promoting patrons to different membership levels based on patron actions.

19. The venue management system as set forth in claim 18, wherein the membership levels include a Family membership, a Season Ticket Holder membership, and a VIP membership.

20. (canceled)

21. A non-transitory computer-readable storage medium with an executable computer program stored thereon, the computer program comprising:
a code segment for receiving identification information for a ticket to an event at a single stationary venue;
a code segment or segments for implementing a rules engine that associates a reward or incentive with the ticket upon occurrence of a trigger;
a code segment for changing the user activity during the event;
a code segment for confirming a trigger occurred at the event; and
a code segment for associating a reward with the user account based on the trigger occurring,
wherein the trigger comprises at least one of:
when a patron uses the ticket to enter the venue at a specified time or date prior to an event;
when a team or group performing in the venue completes a specified action;
when the patron donates a specified amount of money to a cause affiliated with or endorsed by the venue; and
when the patron attends a specified number of events;

22. The computer-readable storage medium as set forth in claim 21, wherein the trigger further comprises when the patron uses the ticket to purchase a specified amount of goods or services in the venue or out of the venue or when the patron accumulates a specified number of loyalty points associated with the ticket.
